(19) United States
(12) Patent Application Publication
(10) Pub. No.: US 2026/0085152 A1
(43) Pub. Date: Mar. 26, 2026

(54) A POLYETHER-BASED DISPERSANT WITH A LIGHT STABILIZING EFFECT

(71) Applicant: BASF SE, Ludwigshafen am Rhein (DE)

(72) Inventors: Huiguang KOU, Ludwigshafen am Rhein (DE); Steffen ONCLIN, Ludwigshafen am Rhein (DE); Johannes Hermann WILLENBACHER, Ludwigshafen am Rhein (DE); Clemens AUSCHRA, Ludwigshafen am Rhein (DE)

(21) Appl. No.: 19/106,245

(22) PCT Filed: Aug. 25, 2023
(86) PCT No.: PCT/EP2023/073352

§ 371 Date: Feb. 25, 2025

(30) Foreign Application Priority Data
Aug. 26, 2022 (EP) 22192451.7

(51) Int. Cl. C08G 65/333; C08G 64/02; C08K 5/00

(52) U.S. Cl. CPC C08G 65/33313; C08G 64/0241; C08K 5/005

(57) ABSTRACT

The presently claimed invention a polymer obtainable by reacting a polyether with a hindered amine light stabilizer (HALS). The presently claimed invention is directed to a method for preparing the polymer. The presently claimed invention is also directed to a liquid composition comprising the polymer and use of the polymer as a dispersant and a light stabilizer.

### FIELD OF THE INVENTION

The presently claimed invention relates to a polymer obtainable by reacting a polyether with a hindered amine light stabilizer (HALS). The presently claimed invention is directed to a method for preparing the polymer. The presently claimed invention is also directed to a liquid composition comprising the polymer and use of the polymer as a dispersant and as a light stabilizer.

### BACKGROUND OF THE INVENTION

Liquid pigment compositions containing pigments and fillers and a liquid vehicle are commonly used for various industrial and consumer technical applications, in particular for colouring coating compositions, including solvent and water-borne paints, heavy duty coatings, automotive coatings, in printing inks, or for colouring cosmetics, plastics, etc.

Therefore, there is an ongoing need for polymers, which are suitable as dispersants for pigments, and which provide high stability, reduced viscosity, in particular at high pigment loadings, and improved optical properties of the coatings, such as gloss, colour intensity, reduced yellowing, rub-out characteristics or reduced cratering.

An important property of a dry coating is the weathering stability, which is driven by the addition of a light stabilizer.

The dispersant property is useful for uniformly dispersing the particulate material such as pigment and filler in the liquid composition, and for the stability of the liquid composition; whereas the light stabilizer property provides weathering stability to the coating obtained from the liquid composition.

In the state of the art, polymers or oligomers bearing light stabilizers are known and described, for instance, in the following references.

U.S. Pat. No. 9,394,244B2 disclosed polyallophanate oligomers comprising ethylenically unsaturated groups and polymer stabilizer groups selected from hindered amine light stabilizers, ultraviolet light absorbers, antioxidants and dihydrocarbylhydroxylamines.

The polymers or oligomers bearing light stabilizers disclosed in the prior arts have limitations, such as having a weak dispersant property or a weak light stabilizer property or both. Accordingly, it is an object of the presently claimed invention to provide a polymer that is useful as a dispersant in liquid composition and has a light stabilizer property. It is an object to provide a polymer having good dispersant properties in a liquid composition such as improved viscosity and improved stability. Further, it is desired that the polymer provides a good light stabilizer effect (good weather stability) to the coating obtained from the liquid composition.

### SUMMARY OF THE INVENTION

It was surprisingly found that the polymer of the presently claimed invention obtainable by reacting a polyether with a hindered amine light stabilizer (HALS) is useful as a dispersant and as a light stabilizer.

Accordingly, an aspect of the presently claimed invention is polymer P obtainable by reacting
at least one polyether A;
at least one hindered amine light stabilizer (HALS) H selected from H1, H2, H3, H4, H5, H6, or mixtures thereof; and
at least one compound B having at least one functional group selected from the group consisting of ester, isocyanate, anhydride, carboxylic acid, or epoxide, and the at least one compound B is selected from B1, B2, B3, B4, B5, or mixtures thereof;
or
at least one polyether A; and
at least one hindered amine light stabilizer selected from H2, H4, H6, or mixtures thereof;
wherein,
the at least one polyether A is selected from at least one polyether of general formula A(a), at least one polyether of general formula A(b), or mixtures thereof;
wherein
(a) the at least one polyether of general formula A(a) is

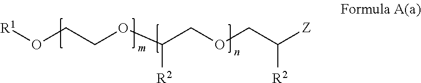

wherein
R¹ is selected from linear or branched, substituted or unsubstituted C₁-C₂₂ alkyl, linear or branched, substituted or unsubstituted C₁-C₂₂ alkylenyl, substituted or unsubstituted C₆-C₁₅ alkylaryl, or substituted or unsubstituted C₆-C₁₄ aryl,
R² is selected from linear or branched, substituted or unsubstituted C₁-C₄ alkyl;
m is an integer in range of 1 to 100;
n is an integer in range of 0 to 100;
m units and n units are distributed to form a random copolymer or a block copolymer or a gradient copolymer; and
Z is selected from —OH, —NH₂, or —NHR³, wherein R³ is selected from linear or branched, substituted or unsubstituted C₁-C₂₂ alkyl;
and
(b) the at least one polyether of general formula A(b) is obtainable by reacting at least one polyether of general formula A(a)

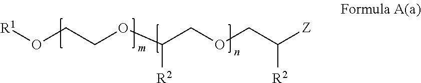

wherein R¹, R², m, n, and Z are as defined above;
with at least one compound of formula (E)

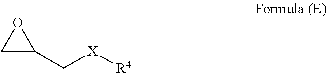

wherein,
R⁴ is selected from linear or branched, substituted or unsubstituted C₁-C₂₂ alkyl, linear or branched, substituted or unsubstituted C₁-C₂₂ alkylenyl, substituted or unsubstituted C₆-C₁₅ alkylaryl, or substituted or unsubstituted C₆-C₁₄ aryl, and
X is selected from O, S or CH₂;
and wherein the molar ratio of the at least one polyether of general formula A(a) and the at least one compound of formula (E) is in the range from 1:0.8 to 1:5;
and
wherein,
a) the hindered amine light stabilizer (HALS) of general formula H1 is

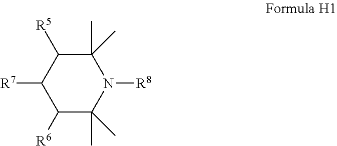

wherein
R⁵ and R⁶ are independently selected from H, or substituted or unsubstituted C₁₋₄ alkyl;
R⁷ is selected from —OH, —NH₂, —NHR⁹, —R¹⁰—OH, —R¹⁰—NH₂, or —R¹⁰—NHR⁹;
R⁸ is selected from —H, —O, linear or branched, substituted or unsubstituted C₁-C₂₂ alkyl, linear or branched, substituted or unsubstituted C₃-C₈ cycloalkyl, —OR¹¹, —R¹²—OH,— or —O—R¹²—OH;
wherein R⁹, and R¹¹ are independently selected from linear or branched, substituted or unsubstituted C₁-C₂₂ alkyl; and
wherein R¹⁰ and R¹² are independently selected from linear or branched, substituted or unsubstituted C₁-C₂₂ alkylene;
b) the hindered amine light stabilizer (HALS) H2 is a HALS copolymer comprising
(i) 4-hydroxy-2,2,6,6-tetramethyl-1-piperidineethanol; and
(ii) at least one dicarboxylic ester of general formula

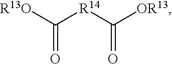

wherein,
R¹³ is selected from linear or branched, substituted or unsubstituted C₁-C₁₂ alkyl; and
R¹⁴ is selected from linear or branched, substituted or unsubstituted C₂-C₁₂ alkylene;
c) the hindered amine light stabilizer (HALS) of general formula H3 is a triazine based dimer having —NH or —OH-functionality

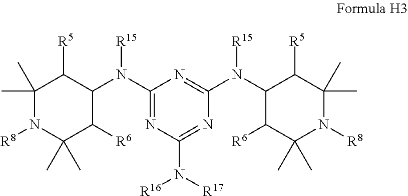

wherein,
R⁵, R⁶, and R⁸ are as defined above;
R¹⁵ is selected from H, or linear or branched, substituted or unsubstituted C₁-C₆ alkyl;
R¹⁶ is selected from H, or linear or branched, substituted or unsubstituted C₁-C₆ alkyl;
R¹⁷ is selected from —H, or —R¹⁸—OH, wherein R¹⁸ is selected from linear or branched, substituted or unsubstituted C₁-C₂₂ alkylene;
d) the hindered amine light stabilizer (HALS) of general formula H4 is a diester or carbonate functionalized HALS compound

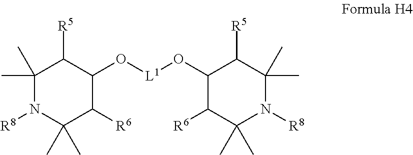

wherein,
R⁵, R⁶, and R⁸ are as defined above;
L¹ is

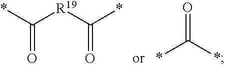

wherein * indicates point of attachment to 0, and
R¹⁹ is selected from linear or branched, substituted or unsubstituted C₁-C₂₂ alkylene;
e) the hindered amine light stabilizer (HALS) H5 is a triazine substituted alkylamine-based oligomer having NH-functionality 1,5,8,12-tetrakis[4,6-bis(N-butyl-N-1,2,2,6,6-pentamethyl-4-piperidylamino)-1,3,5-triazin-2-yl]-1,5,8,12-tetraazadodecane;
f) the hindered amine light stabilizer (HALS) H6 is a polyol polyester tetrakis(1,2,2,6,6-pentamethyl-4-piperidyl) butane-1,2,3,4-tetracarboxylate;
and
wherein
B1 is at least one diester or polyester of general formula R²⁰(COOR²¹)_{q}; wherein
R²⁰ is selected from linear or branched, substituted or unsubstituted C₁-C₂₂-alkylene, or substituted or unsubstituted C₆-C₁₀ arylene;
R²¹ is selected from linear or branched, substituted or unsubstituted C₁-C₁₂-alkyl; and
q is an integer in the range of 2 to 5;
B2 is at least one phthalic anhydride derivative of general formula

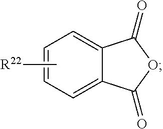

wherein R²² is selected from 4-COOH, 4-NO₂, 4-F, 4-Cl, or 4-Br;
B3 is at least one a diisocyanate or polyisocyanate of general formula

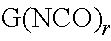

wherein, G is selected from a linear or branched, substituted or unsubstituted C₂-C₂₂ alkyl, linear or branched, substituted or unsubstituted C₃-C₈ cycloalkyl, or substituted or unsubstituted C₆-C₁₄ arylene, and
r is 2 or 3 or 4;
B4 is at least one epoxy polymer; and
B5 is at least one maleic anhydride polymer.

Another aspect of the presently claimed invention is directed to methods for preparing the polymer P.

Yet another aspect of the presently claimed invention is directed to a liquid composition comprising the polymer P.

Yet another aspect of the presently claimed invention is directed to a coating composition comprising
i. the polymer P of the presently claimed invention;
ii. at least one particulate solid material selected from pigments, fillers, or mixtures thereof;
iii. at least one liquid diluent, and
iv. at least one polymeric binder
   wherein the at least one particulate solid material is dispersed in a liquid diluent selected from organic solvents, water, reactive diluents, or mixture thereof.

Yet another aspect of the presently claimed invention is directed to use of the polymer P as a dispersant.

Yet another aspect of the presently claimed invention is directed to use of the polymer P as a light stabilizer.

Yet another aspect of the presently claimed invention is directed to use of the polymer P in a coating composition.

### DETAILED DESCRIPTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein.

In case the terms ‘first’, ‘second’, ‘third’ or ‘(A)’, ‘(B)‘ and’(C)‘ or’(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well i.e., a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment but may refer to so.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

It was surprisingly found that polymers of the presently claimed invention obtainable by reacting a polyether with a hindered amine light stabilizer (HALS) are useful as dispersants and as light stabilizers. Certain HALS, when covalently bound to certain polyether polymers, perform well as dispersants in liquid compositions, and further perform well as light stabilizers. The polyether polymers and the HALS either bound directly through a covalent bond or via a multifunctional compound which is covalently bound to each of them.

The presently claimed invention relates to polymers containing polyether and hindered amine light stabilizers (HALS).

Accordingly, an aspect of the presently claimed invention is directed to a polymer P obtainable by reacting
at least one polyether A;
at least one hindered amine light stabilizer (HALS) H selected from H1, H2, H3, H4, H5, H6, or mixtures thereof; and
at least one compound B having at least one functional group selected from the group consisting of ester, isocyanate, anhydride, carboxylic acid, or epoxide, and the at least one compound B is selected from B1, B2, B3, B4, B5, or mixtures thereof;
or
at least one polyether A; and
at least one hindered amine light stabilizer selected from H2, H4, H6, or mixtures thereof;
wherein,
the at least one polyether A is selected from at least one polyether of general formula A(a), at least one polyether of general formula A(b), or mixtures thereof;
wherein
(a) the at least one polyether of general formula A(a) is

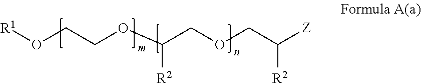

wherein
R¹ is selected from linear or branched, substituted or unsubstituted C₁-C₂₂ alkyl, linear or branched, substituted or unsubstituted C₁-C₂₂ alkylenyl, substituted or unsubstituted C₆-C₁₅ alkylaryl, or substituted or unsubstituted C₆-C₁₄ aryl,
R² is selected from linear or branched, substituted or unsubstituted C₁-C₄ alkyl;
m is an integer in range of 1 to 100;
n is an integer in range of 0 to 100;
m units and n units are distributed to form a random copolymer or a block copolymer or a gradient copolymer; and
Z is selected from —OH, —NH₂, or —NHR³, wherein R³ is selected from linear or branched, substituted or unsubstituted C₁-C₂₂ alkyl;
and
(b) the at least one polyether of general formula A(b) is obtainable by reacting at least one polyether of general formula A(a)

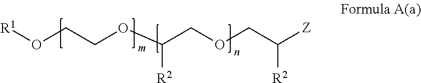

wherein R¹, R², m, n, and Z are as defined above;
with at least one compound of formula (E)

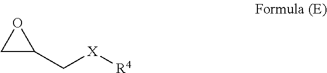

wherein,
R⁴ is selected from linear or branched, substituted or unsubstituted C₁-C₂₂ alkyl, linear or branched, substituted or unsubstituted C₁-C₂₂ alkylenyl, substituted or unsubstituted C₆-C₁₅ alkylaryl, or substituted or unsubstituted C₆-C₁₄ aryl, and
X is selected from O, S or CH₂;
and wherein the molar ratio of the at least one polyether of general formula A(a) and the at least one compound of formula (E) is in the range from 1:0.8 to 1:5;
and
wherein,
a) the hindered amine light stabilizer (HALS) of general formula H1 is

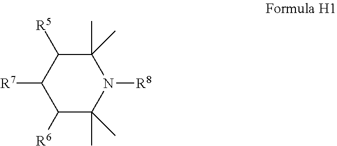

wherein
R⁵ and R⁶ are independently selected from H, or substituted or unsubstituted C₁₋₄ alkyl;
R⁷ is selected from —OH, —NH₂, —NHR⁹, —R¹⁰—OH, —R¹⁰—NH₂, or —R¹⁰—NHR⁹;
R⁸ is selected from —H, —O, linear or branched, substituted or unsubstituted C₁-C₂₂ alkyl, linear or branched, substituted or unsubstituted C₃-C₈ cycloalkyl, —OR¹¹, —R¹²—OH,— or —O—R¹²—OH;
wherein R⁹, and R¹¹ are independently selected from linear or branched, substituted or unsubstituted C₁-C₂₂ alkyl; and
wherein R¹⁰ and R¹² are independently selected from linear or branched, substituted or unsubstituted C₁-C₂₂ alkylene;
b) the hindered amine light stabilizer (HALS) H2 is a HALS copolymer comprising
(i) 4-hydroxy-2,2,6,6-tetramethyl-1-piperidineethanol; and
(ii) at least one dicarboxylic ester of general formula

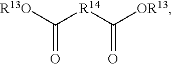

wherein,
R¹³ is selected from linear or branched, substituted or unsubstituted C₁-C₁₂ alkyl; and
R¹⁴ is selected from linear or branched, substituted or unsubstituted C₂-C₁₂ alkylene;
c) the hindered amine light stabilizer (HALS) of general formula H3 is a triazine based dimer having —NH or —OH-functionality

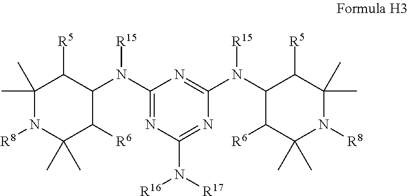

wherein,
R⁵, R⁶, and R⁸ are as defined above;
R¹⁵ is selected from H, or linear or branched, substituted or unsubstituted C₁-C₆ alkyl;
R¹⁶ is selected from H, or linear or branched, substituted or unsubstituted C₁-C₆ alkyl;
R¹⁷ is selected from —H, or —R¹⁸—OH, wherein R¹⁸ is selected from linear or branched, substituted or unsubstituted C₁-C₂₂ alkylene;
d) the hindered amine light stabilizer (HALS) of general formula H4 is a diester or carbonate functionalized HALS compound

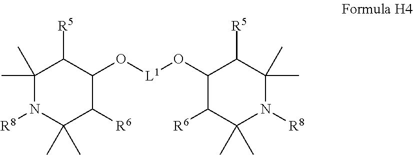

wherein,
R⁵, R⁶, and R⁸ are as defined above;
L₁ is

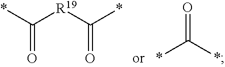

wherein * indicates point of attachment to 0, and
R¹⁹ is selected from linear or branched, substituted or unsubstituted C₁-C₂₂ alkylene;
e) the hindered amine light stabilizer (HALS) H5 is a triazine substituted alkylamine-based oligomer having NH-functionality 1,5,8,12-tetrakis[4,6-bis(N-butyl-N-1,2,2,6,6-pentamethyl-4-piperidylamino)-1,3,5-triazin-2-yl]-1,5,8,12-tetraazadodecane;
f) the hindered amine light stabilizer (HALS) H6 is a polyol polyester tetrakis(1,2,2,6,6-pentamethyl-4-piperidyl) butane-1,2,3,4-tetracarboxylate;
and
wherein
B1 is at least one diester or polyester of general formula R²⁰(COOR²¹)_{q};
wherein
R²⁰ is selected from linear or branched, substituted or unsubstituted C₁-C₂₂-alkylene, and substituted or unsubstituted C₆-C₁₀ arylene;
R²¹ is selected from linear or branched, substituted or unsubstituted C₁-C₁₂-alkyl; and
q is an integer in the range of 2 to 5;
B2 is at least one phthalic anhydride derivative of general formula

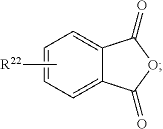

wherein R²² is selected from 4-COOH, 4-NO₂, 4-F, 4-Cl, or 4-Br;
B3 is at least one a diisocyanate or polyisocyanate of general formula

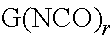

wherein, G is selected from a linear or branched, substituted or unsubstituted C₂-C₂₂ alkyl, linear or branched, substituted or unsubstituted C₃-C₈ cycloalkyl, or substituted or unsubstituted C₆-C₁₄ arylene, and
r is 2 or 3 or 4;
B4 is at least one epoxy polymer; and
B5 is at least one maleic anhydride polymer.

Within the context of the presently claimed invention, the term alkyl, as used herein, refers to an acylic saturated aliphatic groups, including linear and branched alkyl saturated hydrocarbon radical denoted by a general formula CₙH₂ₙ₊₁ and wherein n is the number of carbon atoms 1, 2, 3, 4 etc.

Preferably, the alkyl refers to linear unsubstituted C₁ to C₂₂ carbon atoms, selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl and docosyl.

Preferably, the alkyl refers to branched unsubstituted C₃ to C₂₂ carbon atoms, selected from the group consisting of 1-methyl ethyl, 1-methyl propyl, 2-methyl propyl, 1-methyl butyl, 2-methyl butyl, 3-methyl butyl, 1-methyl pentyl, 2-methyl pentyl, 3-methyl pentyl, 4-methyl pentyl, 1-methyl hexyl, 2-methyl hexyl, 3-methyl hexyl, 4-methyl hexyl, 5-methyl hexyl, 1-methyl heptyl, 2-methyl heptyl, 3-methyl heptyl, 4-methyl heptyl, 5-methyl heptyl, 6-methyl heptyl, 1-methyl octyl, 2-methyl octyl, 3-methyl octyl, 4-methyl octyl, 5-methyl octyl, 6-methyl octyl, 7-methyl octyl, 1-methyl nonyl, 2-methyl nonyl, 3-methyl nonyl, 4-methyl nonyl, 5-methyl nonyl, 6-methyl nonyl, 7-methyl nonyl, 8-methyl nonyl, 1-methyl decyl, 2-methyl decyl, 3-methyl decyl, 4-methyl decyl, 5-methyl decyl, 6-methyl decyl, 7-methyl decyl, 8-methyl decyl, 9-methyl decyl, 1-methyl undecyl, 2-methyl undecyl, 3-methyl undecyl, 4-methyl undecyl, 5-methyl undecyl, 6-methyl undecyl, 7-methyl undecyl, 8-methyl undecyl, 9-methyl undecyl, 10-methyl undecyl, 1-methyl dodecyl, 2-methyl dodecyl, 3-methyl dodecyl, 4-methyl dodecyl, 5-methyl dodecyl, 6-methyl dodecyl, 7-methyl dodecyl, 8-methyl dodecyl, 9-methyl dodecyl, 10-methyl dodecyl, 11-methyl dodecyl, 1-methyl tridecyl, 2-methyl tridecyl, 3-methyl tridecyl, 4-methyl tridecyl, 5-methyl tridecyl, 6-methyl tridecyl, 7-methyl tridecyl, 8-methyl tridecyl, 9-methyl tridecyl, 10-methyl tridecyl, 11-methyl tridecyl, 12-methyl tridecyl, 1-methyl tetradecyl, 2-methyl tetradecyl, 3-methyl tetradecyl, 4-methyl tetradecyl, 5-methyl tetradecyl, 6-methyl tetradecyl, 7-methyl tetradecyl, 8-methyl tetradecyl, 9-methyl tetradecyl, 10-methyl tetradecyl, 11-methyl tetradecyl, 12-methyl tetradecyl, 13-methyl tetradecyl, etc.

Within the context of the presently claimed invention, the term alkenyl, as used herein, refers to an acylic unsaturated aliphatic groups having at least one double bond, including linear alkenyl unsaturated hydrocarbon radical denoted by a general formula CₙH₂ₙ₋₁ and wherein n is the number of carbon atoms 1, 2, 3, 4 etc.

Preferably, the alkenyl refers to linear unsubstituted C₁ to C₂₂ carbon atoms, selected from the group consisting of prop-1-enyl, prop-2-enyl, but-1-enyl, but-2-enyl, but-3-enyl, pent-1-enyl, pent-2-enyl, pent-3-enyl, pent-4-enyl, hex-1-enyl, hex-2-enyl, hex-3-enyl, hex-4-enyl, hex-5-enyl, hept-1-enyl, hept-2-enyl, hept-3-enyl, hept-4-enyl, hept-5-enyl, hept-6-enyl, oct-1-enyl, oct-2-enyl, oct-3-enyl, oct-4-enyl, oct-5-enyl, oct-6-enyl, oct-7-enyl, non-1-enyl, non-2-enyl, non-3-enyl, non-4-enyl, non-5-enyl, non-6-enyl, non-7-enyl, non-8-enyl, dec-1-enyl, dec-2-enyl, dec-3-enyl, dec-4-enyl, dec-5-enyl, dec-6-enyl, dec-7-enyl, dec-8-enyl, dec-9-enyl, undec-1-enyl, undec-2-enyl, undec-3-enyl, undec-4-enyl, undec-5-enyl, undec-6-enyl, undec-7-enyl, undec-8-enyl, undec-9-enyl, undec-10-enyl, dodec-1-enyl, dodec-2-enyl, dodec-3-enyl, dodec-4-enyl, dodec-5-enyl, dodec-6-enyl, dodec-7-enyl, dodec-8-enyl, dodec-9-enyl, dodec-10-enyl, dodec-11-enyl, tridec-1-enyl, tridec-2-enyl, tridec-3-enyl, tridec-4-enyl, tridec-5-enyl, tridec-6-enyl, tridec-7-enyl, tridec-8-enyl, tridec-9-enyl, tridec-10-enyl, tridec-11-enyl, tridec-12-enyl, tetradec-1-enyl, tetradec-2-enyl, tetradec-3-enyl, tetradec-4-enyl, tetradec-5-enyl, tetradec-6-enyl, tetradec-7-enyl, tetradec-8-enyl, tetradec-9-enyl, tetradec-10-enyl, tetradec-11-enyl, tetradec-12-enyl, tetradec-13-enyl, pentadec-1-enyl, pentadec-2-enyl, pentadec-3-enyl, pentadec-4-enyl, pentadec-5-enyl, pentadec-6-enyl, pentadec-7-enyl, pentadec-8-enyl, pentadec-9-enyl, pentadec-10-enyl, pentadec-11-enyl, pentadec-12-enyl, pentadec-13-enyl, pentadec-14-enyl, hexadec-1-enyl, hexadec-2-enyl, hexadec-3-enyl, hexadec-4-enyl, hexadec-5-enyl, hexadec-6-enyl, hexadec-7-enyl, hexadec-8-enyl, hexadec-9-enyl, hexadec-10-enyl, hexadec-11-enyl, hexadec-12-enyl, hexadec-13-enyl, hexadec-14-enyl, hexadec-15-enyl, heptadec-1-enyl, heptadec-2-enyl, heptadec-3-enyl, heptadec-4-enyl, heptadec-5-enyl, heptadec-6-enyl, heptadec-7-enyl, heptadec-8-enyl, heptadec-9-enyl, heptadec-10-enyl, heptadec-11-enyl, heptadec-12-enyl, heptadec-13-enyl, heptadec-14-enyl, heptadec-15-enyl, heptadec-16-enyl, octadec-1-enyl, octadec-2-enyl, octadec-3-enyl, octadec-4-enyl, octadec-5-enyl, octadec-6-enyl, octadec-7-enyl, octadec-8-enyl, octadec-9-enyl, octadec-10-enyl, octadec-11-enyl, octadec-12-enyl, octadec-13-enyl, octadec-14-enyl, octadec-15-enyl, octadec-16-enyl, octadec-17-enyl, nonadec-1-enyl, nonadec-2-enyl, nonadec-3-enyl, nonadec-4-enyl, nonadec-5-enyl, nonadec-6-enyl, nonadec-7-enyl, nonadec-8-enyl, nonadec-9-enyl, nonadec-10-enyl, nonadec-11-enyl, nonadec-12-enyl, nonadec-13-enyl, nonadec-14-enyl, nonadec-15-enyl, nonadec-16-enyl, nonadec-17-enyl, nonadec-18-enyl, icos-1-enyl, icos-2-enyl, icos-3-enyl, icos-4-enyl, icos-5-enyl, icos-6-enyl, icos-7-enyl, icos-8-enyl, icos-9-enyl, icos-10-enyl, icos-11-enyl, icos-12-enyl, icos-13-enyl, icos-14-enyl, icos-15-enyl, icos-16-enyl, icos-17-enyl, icos-18-enyl, icos-19-enyl, henicos-1-enyl, henicos-2-enyl, henicos-3-enyl, henicos-4-enyl, henicos-5-enyl, henicos-6-enyl, henicos-7-enyl, henicos-8-enyl, henicos-9-enyl, henicos-10-enyl, henicos-11-enyl, henicos-12-enyl, henicos-13-enyl, henicos-14-enyl, henicos-15-enyl, henicos-16-enyl, henicos-17-enyl, henicos-18-enyl, henicos-19-enyl, henicos-20-enyl, docos-1-enyl, docos-2-enyl, docos-3-enyl, docos-4-enyl, docos-5-enyl, docos-6-enyl, docos-7-enyl, docos-8-enyl, docos-9-enyl, docos-10-enyl, docos-11-enyl, docos-12-enyl, docos-13-enyl, docos-14-enyl, docos-15-enyl, docos-16-enyl, docos-17-enyl, docos-18-enyl, docos-19-enyl, docos-20-enyl and docos-21-enyl.

Within the context of the presently claimed invention, the term alkylene, as used herein, refers to a saturated, divalent, linear or branched hydrocarbon radical. Examples of such preferred alkylene radicals include methylene, ethane-1,2-diyl, propane-1,3-diyl, propane-1,2-diyl, 2-methylpropane-1,2-diyl, 2,2-dimethylpropane-1,3-diyl, butane-1,4-diyl, butane-1,3-diyl (=1-methyl-propane-1,3-diyl), butane-1,2-diyl, butane-2,3-diyl, 2-methyl-butan-1,3-diyl, 3-methyl-butan-1,3-diyl (=1,1-dimethylpropane-1,3-diyl), pentane-1,4-diyl, pentane-1,5-diyl, pentane-2,5-diyl, 2-methylpentane-2,5-diyl (=1,1-dimethylbutane-1,3-diyl) and hexane-1,6-diyl.

Within the context of the presently claimed invention, the term cycloalkyl, as used herein, refers to a monocyclic and a bicyclic 3 to 15 membered saturated cycloaliphatic groups, including branched cycloalkyl saturated hydrocarbon.

Preferably, the cycloalkyl refers to C₃ to C₁₅ carbon atoms, selected from the group consisting of cyclopropyl, cyclobutyl, cyclopentyl, cyclohexyl, cycloheptyl, cyclooctyl, cyclononyl, cyclodecyl, cycloundecyl, cycloeodecyl, cyclotridecyl, cyclotetradecyl and cyclopentadecyl.

Within the context of the presently claimed invention, the term aryl, as used herein, refers to phenyl or naphthyl, preferably phenyl. The term substituted aryl refers to an aryl radical wherein a part or all the hydrogen atoms are replaced by substituent/s, preferably the substituents are selected from hydroxy, halogen, cyano, C₁-C₄-alkyl and C₁-C₄-alkoxy. Preferably aryl is unsubstituted or carries 1, 2 or 3 substituents.

Within the context of the presently claimed invention, the term “alkylaryl”, as used herein, refers to in each case an alkyl-substituted aryl radical, wherein one hydrogen atom at any position of the alkyl carbon backbone is replaced by an aryl moiety. Preferably, arylalkyl is benzyl (—CH₂—C₆H₅), ethylphenyl (—CH₂—CH₂—C₆H₅, —(CH₃)CH—C₆H₅), etc.

Within the context of the presently claimed invention, the term “pigment material” includes both pigments and fillers, and thus relates to pigments, fillers or mixtures of pigments and fillers.

Within the context of the presently claimed invention, the term “D50” refers to the median particle size, where fifty percent of the distribution has a smaller particle size, and fifty percent of the distribution has a larger particle size.

In a preferred embodiment, the polymer P is obtainable by reacting
a) the at least one polyether A;
b) the at least one hindered amine light stabilizer (HALS) H selected from H1, H2, H3, H4, H5, H6, or mixtures thereof; and
c) the at least one compound B having at least one functional group selected from the group consisting of ester, isocyanate, anhydride, carboxylic acid, or epoxide, and the at least one compound B is selected from B1, B2, B3, B4, B5, or mixtures thereof.

In a preferred embodiment, the polymer P is obtainable by reacting
a) the at least one polyether A; and
b) the at least one hindered amine light stabilizer selected from H2, H4, H6, or mixtures thereof.

In a preferred embodiment, the polymer P is obtainable by reacting
a) the at least one polyether A(a);
b) the at least one hindered amine light stabilizer (HALS) H selected from H1, H2, H3, H4, H5, H6, or mixtures thereof; and
c) the at least one compound B having at least one functional group selected from the group consisting of ester, isocyanate, anhydride, carboxylic acid, or epoxide, and the at least one compound B is selected from B1, B2, B3, B4, B5, or mixtures thereof.

In a preferred embodiment, the polymer P is obtainable by reacting
a) the at least one polyether A(b), wherein X is O;
b) the at least one hindered amine light stabilizer (HALS) H selected from H1, H2, H3, H4, H5, H6, or mixtures thereof; and
c) the at least one compound B having at least one functional group selected from the group consisting of ester, isocyanate, anhydride, carboxylic acid, or epoxide, and the at least one compound B is selected from B1, B2, B3, B4, B5, or mixtures thereof.

In a preferred embodiment, the polymer P is obtainable by reacting
a) the at least one polyether A(b), wherein X is CH₂;
b) the at least one hindered amine light stabilizer (HALS) H selected from H1, H2, H3, H4, H5, H6, or mixtures thereof; and
c) the at least one compound B having at least one functional group selected from the group consisting of ester, isocyanate, anhydride, carboxylic acid, or epoxide, and the at least one compound B is selected from B1, B2, B3, B4, B5, or mixtures thereof.

In a preferred embodiment, the polymer P is obtainable by reacting
a) the at least one polyether A(a); and
b) the at least one hindered amine light stabilizer selected from H2, H4, H6, or mixtures thereof.

In a preferred embodiment, the polymer P is obtainable by reacting
a) the at least one polyether A(b), wherein X is O; and
b) the at least one hindered amine light stabilizer selected from H2, H4, H6, or mixtures thereof.

In a preferred embodiment, the polymer is obtainable by reacting
a) the at least one polyether A(b), wherein X is CH₂; and
b) the at least one hindered amine light stabilizer selected from H2, H4, H6, or mixtures thereof.

In a preferred embodiment,
m is an integer in the range of 1 to 50; and
n is an integer in the range of 1 to 50.

In a more preferred embodiment,
m is an integer in the range of 1 to 25; and
n is an integer in the range of 1 to 25.

In a preferred embodiment, the at least one polyether A is at least one polyether of general formula A(a).

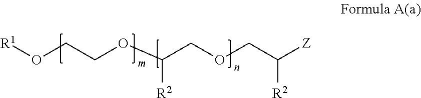

In a preferred embodiment, R¹ is —CH₃.

In a preferred embodiment, the at least one polyether of formula A(a) is a copolymer comprising ethylene oxide and propylene oxide.

In a preferred embodiment, R² is —CH₃.

In a preferred embodiment, R² is —CH₃, and Z is NH₂.

In a preferred embodiment, the at least one polyether of general formula A(a) is a block copolymer of ethylene oxide and propylene oxide having a weight average molecular weight of 2000 g/mol, according to DIN 55672-1.

In a preferred embodiment, R² is —CH₃, and Z is OH.

In a preferred embodiment, the at least one polyether of general formula A(a) is a block copolymer comprising ethylene oxide and propylene oxide having a weight average molecular weight of 1950 g/mol, according to DIN 55672-1.

In a preferred embodiment, the at least one polyether A is a homopolymer comprising ethylene oxide.

In a preferred embodiment, m is an integer in range of 1 to 100; and n is 0.

In a more preferred embodiment, m is an integer in range of 1 to 50; and n is 0.

In a most preferred embodiment, m is an integer in range of 1 to 25; and n is 0.

In a preferred embodiment, Z is —OH.

In a preferred embodiment, the at least one polyether of general formula A(a) is methoxypolyethylene glycol having a weight average molecular weight of 500 g/mol, according to DIN 55672-1.

In a preferred embodiment, the at least one polyether A is the at least one polyether of general formula A(b) is obtainable by reacting at least one polyether of general formula A(a)

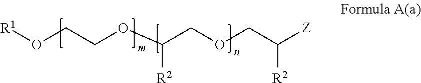

wherein R¹, R², m, n, and Z are as defined above;
with at least one compound of formula (E).

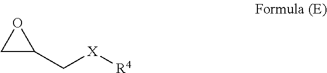

In a preferred embodiment, the molar ratio of the at least one polyether of general formula A(a) and the at least one compound of formula (E) is in the range from 1:0.8 to 1:5; more preferably 1:0/8 to 1:3; and most preferably 1:0.8 to 1:2.

In a preferred embodiment, the at least one polyether of general formula A(b) is obtainable by reacting at least one polyether of general formula A(a) with at least one compound of formula (E), wherein R⁴ is 2-ethylhexyl, and X═O; and the molar ratio of the at least one polyether of general formula A(a) and the at least one compound of formula (E) is in the range from 1:0.8 to 1:2.

In a preferred embodiment, the at least one polyether of general formula A(b) is obtainable by reacting at least one polyether of general formula A(a) with at least one compound of formula (E), wherein R⁴ is hexadecyl, and X═O; and the molar ratio of the at least one polyether of general formula A(a) and the at least one compound of formula (E) is in the range from 1:0.8 to 1:2.

In a preferred embodiment, the at least one HALS of formula H1 is selected from 4-hydroxy-2,2,6,6-tetramethylpiperidinyloxyl, 4-amino-2,2,6,6-tetramethyl-piperidinyloxyl, 4-hydroxy-2,2,6,6-tetramethylpiperidine, 4-amino-2,2,6,6-tetramethyl-piperidine, 4-hydroxy-1,2,2,6,6-pentamethyl-piperidine, or 4-hydroxy-1-(2-hydroxyethyl)-2,2,6,6-tetramethylpiperidine.

In a preferred embodiment, the at least one HALS of formula H1 is 4-hydroxy-2,2,6,6-tetramethylpiperidinyloxyl (H1-a).

In a preferred embodiment, the at least one HALS of formula H1 is 4-amino-2,2,6,6-tetramethylpiperidinyloxyl (H1-b).

In a preferred embodiment, the at least one HALS of formula H1 is 4-hydroxy-2,2,6,6-tetramethylpiperidine (H1-c).

In a preferred embodiment, the at least one HALS of formula H1 is 4-amino-2,2,6,6-tetramethylpiperidine (H1-d).

In a preferred embodiment, the at least one HALS of formula H1 is 4-hydroxy-1,2,2,6,6-pentamethyl-piperidine (H1-e).

In a preferred embodiment, the at least one HALS of formula H1 is 4-hydroxy-1-(2-hydroxyethyl)-2,2,6,6-tetramethylpiperidine (H1-f).

In a preferred embodiment, the at least one HALS H2 is a copolymer comprising dimethyl succinate polymer and 4-hydroxy-2,2,6,6-tetramethyl-1-piperidineethanol having a weight average molecular weight of 7000 g/mol according to DIN 55672-1.

In a preferred embodiment, the at least one HALS of general formula H3 is

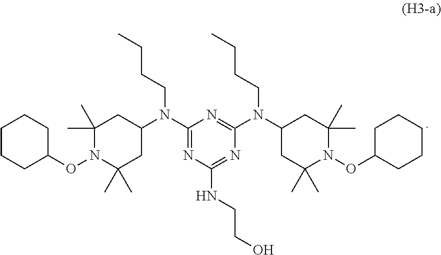

In a preferred embodiment, the at least one HALS of general formula H4 is a diester selected from

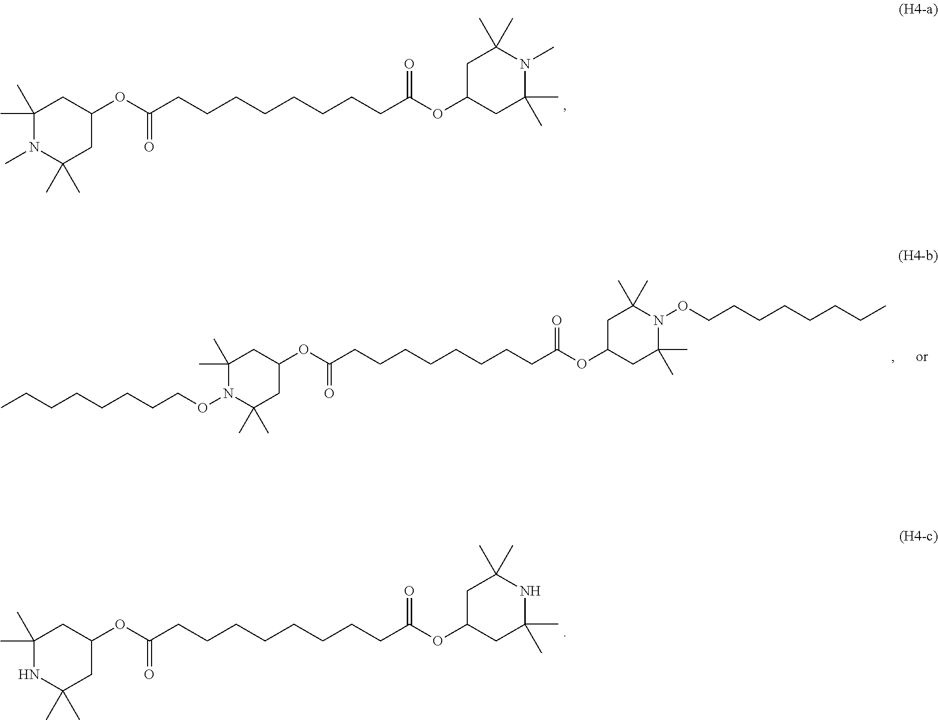

In a preferred embodiment, the at least one HALS of formula H4 is a carbonate

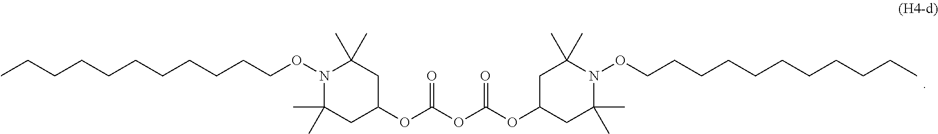 [SMILES: CCCCCCCCCCCON1C(C)(C)CC(OC(=O)OC(=O)OC2CC(C)(C)N(OCCCCCCCCCCC)C(C)(C)C2)CC1(C)C]

In a preferred embodiment, the at least one HALS of formula H4 is

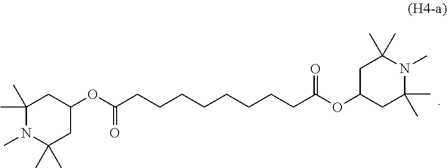

In a preferred embodiment, the at least one HALS of formula H4 is

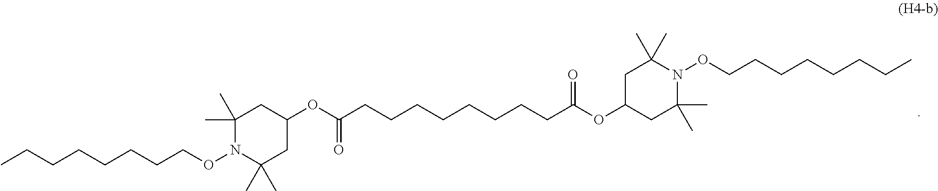 [SMILES: CCCCCCCCON1C(C)(C)CC(OC(=O)CCCCCCCCC(=O)OC2CC(C)(C)N(OCCCCCCCC)C(C)(C)C2)CC1(C)C]

In a preferred embodiment, the at least one HALS of formula H4 is

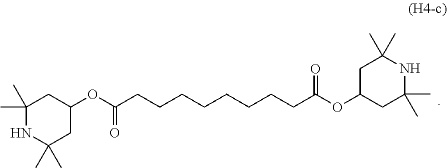

In a preferred embodiment, the at least one HALS H5 is 1,5,8,12-tetrakis[4,6-bis(N-butyl-N-1,2,2,6,6-pentamethyl-4-piperidylamino)-1,3,5-triazin-2-yl]-1,5,8,12-tetraazadodecane.

In a preferred embodiment, the at least one HALS H6 is tetrakis(1,2,2,6,6-pentamethyl-4-piperidyl)butane-1,2,3,4-tetracarboxylate.

Commercially available HALS, including those under the tradenames Tinuvin®622, Tinuvin®152, Chimassorb®119, Tinuvin®770, Tinuvin®292, and Tinuvin®123, can be used in the presently claimed invention.

In a preferred embodiment, the at least one diester or polyester B1 is selected from dimethyl succinate, diethyl succinate, or 1,2-cyclohexandicarboxylic diisononylester.

In a more preferred embodiment, the at least one diester or polyester B1 is dimethyl succinate (B1-a).

In a preferred embodiment, the at least one phthalic anhydride derivative B2 is trimelittic anhydride (B2-a).

In a preferred embodiment, the at least one diisocyanate or polyisocyanate B3 is selected from 2,4-toluene diisocyanate, 2,6-toluene diisocyanate, isophorondiisocyante, hexamethylene diisocyanate, or their dimer or trimer.

In a more preferred embodiment, the at least one diisocyanate B3 is 2,4-toluene diisocyanate (B3-a).

In a more preferred embodiment, the at least one diisocyanate B3 is a mixture of 2,4-toluene diisocyanate, and 2,6-toluene diisocyanate.

In a more preferred embodiment, the at least one diisocyanate B3 is selected from isophorondiisocyante, hexamethylene diisocyanate, or their dimer or trimer.

Commercially available isocyanates comprise a mixture of monomeric form as well as polymeric form such as dimer and trimer of the isocyanate. The mixture can also be used for the presently claimed invention.

In a preferred embodiment, the at least one epoxy polymer B4 comprises a monomer selected from trimethylolpropane triglycidyl ether, or bisphenol A diglycidyl ether.

In a more preferred embodiment, the at least one epoxy polymer B4 comprises trimethylolpropane triglycidyl ether.

In a preferred embodiment, the at least one maleic anhydride polymer B5 is styrene maleic anhydride copolymer.

In a preferred embodiment, the at least one maleic anhydride polymer B5 is selected from styrene maleic anhydride copolymer having a weight average molecular weight in the range of 500 g/mol to 10,000 g/mol according to DIN 55672-1.

In a preferred embodiment, polymer P is obtainable by reacting one polyether A, and one hindered amine light stabilizer (HALS) H.

In a preferred embodiment, polymer P is obtainable by reacting
one polyether A selected from A1, A2, A4 or A5; and
hindered amine light stabilizer (HALS) H2-a.

In a preferred embodiment, polymer P is obtainable by reacting one polyether A, one hindered amine light stabilizer (HALS) H, and one compound B.

In a preferred embodiment, polymer P is obtainable by reacting
compound B1-a;
one polyether A selected from A1, A3, A4 or A5; and
one hindered amine light stabilizer (HALS) H selected from H1-b, H1-d, H1-f, H-2a, H-3a, H4-a, H-4b, H-4c, H-4d, H-5 or H-6.

In a preferred embodiment, polymer P is obtainable by reacting
compound B2-a;
one polyether A selected from A3, or A4; and
one hindered amine light stabilizer (HALS) H selected from H1-a, H1-c, or H1-e.

In a preferred embodiment, polymer P is obtainable by reacting
one compound B selected from B3-a or B3-b;
one polyether A selected from A1, A2, or A5; and
one hindered amine light stabilizer (HALS) H selected from H1-a, H1-c, or H-3a.

In a preferred embodiment, polymer P is obtainable by reacting
compound B4-a;
one polyether A selected from A1, A2, A3, or A5; and
one hindered amine light stabilizer (HALS) H selected from H1-b, H1-d, or H5-a.

In a preferred embodiment, polymer P is obtainable by reacting
one compound B selected from B5-a or B-5b;
polyether A1; and
one hindered amine light stabilizer (HALS) H selected from H1-b, or H1-d.

In a preferred embodiment, polymer P is obtainable by reacting
compound B1-a;
one polyether A selected from A1, A3, A4 or A5; and
one hindered amine light stabilizer (HALS) H selected from H1-b, H1-d, H1-f, H-3a or H-5.

In a preferred embodiment, polymer P is obtainable by reacting a polyether A, two hindered amine light stabilizers (HALS), and a compound B.

In a preferred embodiment, polymer P is obtainable by reacting
compound B1-a;
one polyether A selected from A1, A3, A4 or A5; and
one hindered amine light stabilizer (HALS) H selected from H-2a, H4-a, or H4-b.

In a preferred embodiment, polymer P is obtainable by reacting a polyether A, three hindered amine light stabilizers (HALS), and a compound B.

In a preferred embodiment, polymer P is obtainable by reacting
compound B1-a;
polyether A3; and
hindered amine light stabilizer (HALS) H H-2a, H4-a, and H4-b.

### Polymer P

In a preferred embodiment, the polymer P has a weight average molecular weight in the range of 200 g/mol to 100,000 g/mol according to DIN 55672-1.

In a preferred embodiment, the polymer P has a weight average molecular weight in the range of 500 g/mol to 50,000 g/mol according to DIN 55672-1.

In a preferred embodiment, the polymer P has a weight average molecular weight in the range of 2000 g/mol to 50,000 g/mol according to DIN 55672-1.

In a preferred embodiment, the polymer P has a polydispersity index in the range of 1.1 to 4.0 according to according to DIN 55672-1.

In a preferred embodiment, the polymer P has a HALS content from 0.1 to 3.5 mmol HASL/g.

In a preferred embodiment, the polymer P has HALS content from 0.2 to 3.0 mmol HASL/g.

### Method for Preparation

Another aspect of the presently claimed invention is directed to a method for preparing the polymer P comprising
i. mixing the at least one polyether A and the at least one hindered amine light stabilizer H selected from H2, H4, H6, or mixtures thereof; and
ii. heating the mixture obtained in step (i) at 80° C. to 200° C.

H2, H4 and H6 compounds are esters, and these esters react with the terminal amine or hydroxy group of the at least one polyether to provide the polymer P.

In a preferred embodiment, the method further comprises adding at least one catalyst selected from tetrabutyl titanate, or dibutyltin dilaurate to the mixture obtained in step (i).

In a preferred embodiment, the amount of the at least one catalyst is in the range of 0.1 to 5.0 wt. % based on the total amount of the reaction mixture.

In a preferred embodiment, the amount of the at least one catalyst is in the range of 0.25 to 1.0 wt. % based on the total amount of the reaction mixture.

Another aspect of the presently claimed invention is directed to a method for preparing the polymer P comprising
i. mixing the at least one polyether A, the at least one hindered amine light stabilizer H selected from H1, H2, H3, H4, H5, H6, or mixtures thereof, and the at least one compound B selected from B1, B2, or B5; and
ii. heating the mixture obtained in step (i) at 80° C. to 200° C.

B1, B2, and B5 compounds bear a functional group selected from ester, or anhydride. These compounds react with the terminal amine or hydroxy group of the at least one polyether P.

In a preferred embodiment, the method further comprises adding at least one catalyst selected from tetrabutyl titanate, or dibutyltin dilaurate to the mixture obtained in step (i).

In a preferred embodiment, the amount of the at least one catalyst is in the range of 0.1 to 5.0 wt. % based on the total amount of the reaction mixture.

In a preferred embodiment, the amount of the at least one catalyst is in the range of 0.25 to 1.0 wt. % based on the total amount of the reaction mixture.

Another aspect of the presently claimed invention is directed to a method for preparing the polymer P comprising
(i) reacting the at least one polyether A and the at least one compound B selected from B3 or B4; and
(ii) reacting the product obtained in step (i) with the at least one hindered amine light stabilizer H selected from H1, H2, H3, H4, H5, H6, or mixtures thereof.

B3 and B4 compounds bear a group selected from isocyanate or epoxide. These compounds react with the terminal amine or hydroxy group of the at least one polyether.

In a preferred embodiment, the method further comprises adding at least one solvent in step (i); wherein the at least one solvent is selected from ethyl acetate, or methoxypropyl acetate.

In a preferred embodiment, the method further comprises adding at least one catalyst in an amount in the range of 0.1 to 5.0 wt. % based on the total amount of the reaction mixture.

In a preferred embodiment, the at least one catalyst is aluminum trichloride.

In a preferred embodiment, step (i) is carried out at 40° C. to 120° C.

In a preferred embodiment, step (ii) is carried out at 50° C. to 200° C.

### Compositions and Applications

Another aspect of the presently claimed invention is directed to a liquid composition comprising the polymer P.

Another aspect of the presently claimed invention is directed to a liquid composition in the form of a dispersion comprising at least one fine particulate solid material and the at least one polymer P.

In a preferred embodiment, the at least one fine particulate solid material has a particle size D₅₀ in the range of 0.005 um to 100 um according to dynamic light scattering technique with a fixed scattering angle of 90° or 180°.

In a preferred embodiment, the at least one fine particulate solid material is at least one pigment.

In a preferred embodiment, the at least one particulate solid material is a mixture of at least one pigment, and at least one filler.

In a preferred embodiment, the liquid composition comprises a liquid diluent.

In a preferred embodiment, the liquid composition further comprises at least one additive selected from binder, wetting agent, rheology modifier, UV filter, defoamer, leveling agent, slip agent, substrate wetting agent, antioxidant, radical scavenger, biocide, and coalescing agent.

In a preferred embodiment, the liquid composition is in the form of a pigment paste, a millbase, a colorant, a coating composition, or an ink.

In a preferred embodiment, the liquid composition is formulated as a pigment paste. In a more preferred embodiment, the pigment paste comprises the at least one particulate solid material, the at least one polymer P of the presently claimed invention, at least one liquid diluent, and at least one defoamer.

In a preferred embodiment, the pigment paste does not contain a binder.

The pigment paste (pigment concentrate or millbase) prepared using polymer P as dispersant exhibit very good performance. The pigment paste has a low millbase viscosity. The pigment paste shows excellent storage stability. The viscosity of the millbase does not increase upon storage.

In a preferred embodiment, the coating composition comprises
i. the polymer P of the presently claimed invention;
ii. at least one particulate solid material selected from pigments, fillers, or mixtures thereof;
iii. at least one liquid diluent, and
iv. at least one polymeric binder
   wherein the at least one particulate solid material is dispersed in a liquid diluent selected from organic solvents, water, reactive diluents, or mixture thereof.

In a preferred embodiment, the coating composition comprises
i. 0.1 to 50 wt. % based on the total weight of the liquid composition, of the polymer of the presently claimed invention;
ii. 1 to 70 wt. % based on the total weight of the coating composition, of the at least one fine particulate solid material;
iii. 10 to 98 wt. % based on the total weight of the liquid composition, of the at least one liquid diluent; and
iv. 10 to 98 wt. % based on the total weight of the liquid composition, of the at least one binder.

In a preferred embodiment, the coating composition is prepared by dispersing the fine particulate solid material in the liquid diluent in the presence of the polymer P of the presently claimed invention. The coating composition further comprises an additive. Dispersion is achieved by using conventional techniques such as high-speed mixing, ball milling, sand grinding, attritor grinding, or two or three roll milling.

In a preferred embodiment, the liquid diluent is water.

In a preferred embodiment, the liquid diluent is a mixture of water, and other diluent selected from C₁-C₄ alcohols, glycol ethers, and polyols. The C₁-C₄ alcohols are selected from methanol, ethanol, isopropanol, propanol, or n-butanol. The glycol ethers are selected from butyl glycol, or methoxypropylene glycol. The polyols are selected from glycerol, ethylene glycol, diethylene glycol, triethylene glycol or propylene glycol.

In a preferred embodiment, the binder is an acrylic binder.

The coating compositions prepared using polymer P show good weather stability property. The coats prepared using coating compositions comprising polymer P exhibit a low delta E value.

Another aspect of the presently claimed invention is directed to use of the polymer P of presently claimed invention as a dispersant.

Another aspect of the presently claimed invention is directed to use of the polymer P of the presently claimed invention as a light stabilizer.

Another aspect of the presently claimed invention is directed to use of the polymer P of the presently claimed invention in a coating composition.

The presently claimed invention offers one or more of the following advantages:
1. The polymer of the presently claimed invention is capable of being used as part of a liquid composition as a dispersant.
2. A pigment paste (pigment concentrate or millbase) prepared using polymer P as dispersant exhibits very good performance with a low millbase viscosity.
3. The pigment paste shows excellent storage stability. The viscosity of the millbase does not increase upon storage.
4. A coating composition prepared using polymer P show good weather stability property.
5. The coat prepared using coating compositions comprising polymer P exhibit excellent light stabilizer property with a low delta E value.
6. The polymer of the presently claimed invention does not interfere with the native properties of the dye/pigments.
7. The polymer of the presently claimed invention, when used as a dispersant, allows waterbased processability of coating compositions, thus improving their compliance with environmental and safety norms.

In the following, there are provided a list of embodiments to further illustrate the present disclosure without intending to limit the disclosure to specific embodiments listed below.
1. A polymer P obtainable by reacting
   at least one polyether A;
   at least one hindered amine light stabilizer (HALS) H selected from H1, H2, H3, H4, H5, H6, or mixtures thereof; and
   at least one compound B having at least one functional group selected from the group consisting of ester, isocyanate, anhydride, carboxylic acid, or epoxide, and the at least one compound B is selected from B1, B2, B3, B4, B5, or mixtures thereof; or
   at least one polyether A; and
   at least one hindered amine light stabilizer selected from H2, H4, H6, or mixtures thereof;
wherein,
the at least one polyether A is selected from at least one polyether of general formula A(a), at least one polyether of general formula A(b), or mixtures thereof;
wherein
(a) the at least one polyether of general formula A(a) is

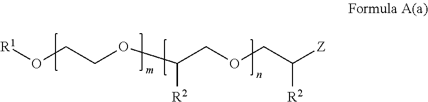

wherein
R¹ is selected from linear or branched, substituted or unsubstituted C₁-C₂₂ alkyl, linear or branched, substituted or unsubstituted C₁-C₂₂ alkylenyl, substituted or unsubstituted C₆-C₁₅ alkylaryl, or substituted or unsubstituted C₆-C₁₄ aryl,
R² is selected from linear or branched, substituted or unsubstituted C₁-C₄ alkyl;
m is an integer in range of 1 to 100;
n is an integer in range of 0 to 100;
m units and n units are distributed to form a random copolymer or a block copolymer or a gradient copolymer; and
Z is selected from —OH, —NH₂, or —NHR³, wherein R³ is selected from linear or branched, substituted or unsubstituted C₁-C₂₂ alkyl;
and
(b) the at least one polyether of general formula A(b) is obtainable by reacting at least one polyether of general formula A(a)

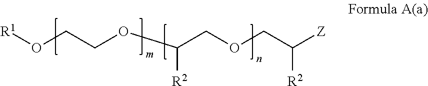

wherein R¹, R², m, n, and Z are as defined above;
with at least one compound of formula (E)

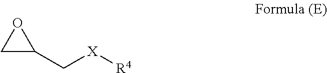

wherein,
R⁴ is selected from linear or branched, substituted or unsubstituted C₁-C₂₂ alkyl, linear or branched, substituted or unsubstituted C₁-C₂₂ alkylenyl, substituted or unsubstituted C₆-C₁₅ alkylaryl, or substituted or unsubstituted C₆-C₁₄ aryl, and
X is selected from O, S or CH₂;
and wherein the molar ratio of the at least one polyether of general formula A(a) and the at least one compound of formula (E) is in the range from 1:0.8 to 1:5;
and
wherein,
a) the hindered amine light stabilizer (HALS) of general formula H1 is

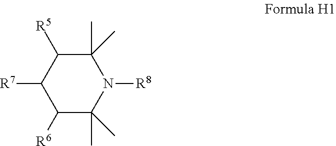

wherein
R⁵ and R⁶ are independently selected from H, or substituted or unsubstituted C₁₋₄ alkyl;
R⁷ is selected from —OH, —NH₂, —NHR⁹, —R¹⁰—OH, —R¹⁰—NH₂, or —R¹⁰—NHR⁹;
R⁸ is selected from —H, —O, linear or branched, substituted or unsubstituted C₁-C₂₂ alkyl, linear or branched, substituted or unsubstituted C₃-C₈ cycloalkyl, —OR¹¹,
—R¹²—OH,— or —O—R¹²—OH;
wherein R⁹, and R¹¹ are independently selected from linear or branched, substituted or unsubstituted C₁-C₂₂ alkyl; and
wherein R¹⁰ and R¹² are independently selected from linear or branched, substituted or unsubstituted C₁-C₂₂ alkylene;
b) the hindered amine light stabilizer (HALS) H2 is a HALS copolymer comprising
(i) 4-hydroxy-2,2,6,6-tetramethyl-1-piperidineethanol; and
(ii) at least one dicarboxylic ester of general formula

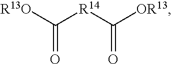

wherein,
R¹³ is selected from linear or branched, substituted or unsubstituted C₁-C₁₂ alkyl; and
R¹⁴ is selected from linear or branched, substituted or unsubstituted C₂-C₁₂ alkylene;
c) the hindered amine light stabilizer (HALS) of general formula H3 is a triazine based dimer having —NH or —OH-functionality

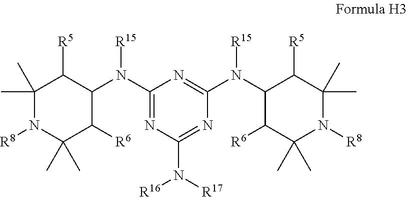

wherein,
R⁵, R⁶, and R⁸ are as defined above;
R¹⁵ is selected from H, or linear or branched, substituted or unsubstituted C₁-C₆ alkyl;
R¹⁶ is selected from H, or linear or branched, substituted or unsubstituted C₁-C₆ alkyl;
R¹⁷ is selected from —H, or —R¹⁸—OH, wherein R¹⁸ is selected from linear or branched, substituted or unsubstituted C₁-C₂₂ alkylene;
d) the hindered amine light stabilizer (HALS) of general formula H4 is a diester or carbonate functionalized HALS compound

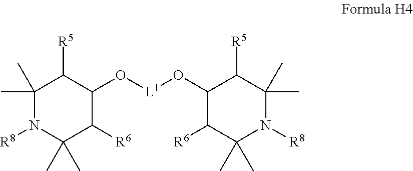

wherein,
R⁵, R⁶, and R⁸ are as defined above;
L¹ is

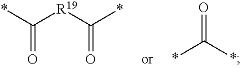

wherein * indicates point of attachment to O, and
R¹⁹ is selected from linear or branched, substituted or unsubstituted C₁-C₂₂ alkylene;
e) the hindered amine light stabilizer (HALS) H5 is a triazine substituted alkylamine-based oligomer having NH-functionality 1,5,8,12-tetrakis[4,6-bis(N-butyl-N-1,2,2,6,6-pentamethyl-4-piperidylamino)-1,3,5-triazin-2-yl]-1,5,8,12-tetraazadodecane;
f) the hindered amine light stabilizer (HALS) H6 is a polyol polyester tetrakis(1,2,2,6,6-pentamethyl-4-piperidyl) butane-1,2,3,4-tetracarboxylate;
and
wherein,
B1 is at least one diester or polyester of general formula R²⁰(COOR²¹)_{q};
wherein
R²⁰ is selected from linear or branched, substituted or unsubstituted C₁-C₂₂-alkylene, or substituted or unsubstituted C₆-C₁₀ arylene;
R²¹ is selected from linear or branched, substituted or unsubstituted C₁-C₁₂-alkyl; and
q is an integer in the range of 2 to 5;
B2 is at least one phthalic anhydride derivative of general formula

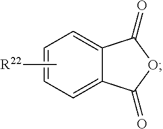

wherein R²² is selected from 4-COOH, 4-NO₂, 4-F, 4-Cl, or 4-Br;
B3 is at least one a diisocyanate or polyisocyanate of general formula G(NCO)ᵣ
wherein, G is selected from a linear or branched, substituted or unsubstituted C₂-C₂₂ alkyl, linear or branched, substituted or unsubstituted C₃-C₅ cycloalkyl, or substituted or unsubstituted C₆-C₁₄ arylene, and
r is 2 or 3 or 4;
B4 is at least one epoxy polymer; and
B5 is at least one maleic anhydride polymer.
2. The polymer P according to embodiment 1 obtainable by reacting
   a) the at least one polyether A(a);
   b) the at least one hindered amine light stabilizer (HALS) H selected from H1, H2, H3, H4, H5, H6, or mixtures thereof; and
   c) the at least one compound B having at least one functional group selected from the group consisting of ester, isocyanate, anhydride, carboxylic acid, or epoxide, and the at least one compound B is selected from B1, B2, B3, B4, B5, or mixtures thereof.
3. The polymer P according to embodiment 1 obtainable by reacting
   a) the at least one polyether A(b), wherein X is O;
   b) the at least one hindered amine light stabilizer (HALS) H selected from H1, H2, H3, H4, H5, H6, or mixtures thereof; and
   c) the at least one compound B having at least one functional group selected from the group consisting of ester, isocyanate, anhydride, carboxylic acid, or epoxide, and the at least one compound B is selected from B1, B2, B3, B4, B5, or mixtures thereof.
4. The polymer P according to embodiment 1 obtainable by reacting
   a) the at least one polyether A(b), wherein X is CH₂;
   b) the at least one hindered amine light stabilizer (HALS) H selected from H1, H2, H3, H4, H5, H6, or mixtures thereof; and
   c) the at least one compound B having at least one functional group selected from the group consisting of ester, isocyanate, anhydride, carboxylic acid, or epoxide, and the at least one compound B is selected from B1, B2, B3, B4, B5, or mixtures thereof.
5. The polymer P according to embodiment 1 obtainable by reacting
   a) the at least one polyether A(a); and
   b) the at least one hindered amine light stabilizer selected from H2, H4, H6, or mixtures thereof.
6. The polymer P according to embodiment 1 obtainable by reacting
   a) the at least one polyether A(b), wherein X is O; and
   b) the at least one hindered amine light stabilizer selected from H2, H4, H6, or mixtures thereof.
7. The polymer P according to embodiment 1 obtainable by reacting
   a) the at least one polyether A(b), wherein X is CH₂; and
   b) the at least one hindered amine light stabilizer selected from H2, H4, H6, or mixtures thereof.
8. The polymer P according to any of embodiments 1 to 7, wherein R¹ is selected from linear or branched, substituted or unsubstituted C₁-C₂₂ alkyl.
9. The polymer P according to any of embodiments 1 to 8, wherein R¹ is —CH₃.
10. The polymer P according to any of embodiments 1 to 9, wherein
   m is an integer in the range of 1 to 50; and
   n is an integer in the range of 1 to 50.
11. The polymer P according to any of embodiments 1 to 10, wherein R² is —CH₃.
12. The polymer P according to any of embodiments 1 to 11, wherein R² is —CH₃, and Z is NH₂.
13. The polymer P according to embodiment 12, wherein the at least one polyether of general formula A(a) is a block copolymer of ethylene oxide and propylene oxide having a weight average molecular weight of 2000 g/mol, according to DIN 55672-1.
14. The polymer P according to any of embodiments 1 to 11, wherein R² is —CH₃, and Z is OH.
15. The polymer P according to embodiment 14, wherein the at least one polyether of general formula A(a) is a block copolymer comprising ethylene oxide and propylene oxide having a weight average molecular weight of 1950 g/mol, according to DIN 55672-1.
16. The polymer P according to any of embodiments 1 to 9, wherein
   m is an integer in range of 1 to 100; and
   n is 0.
17. The polymer P according to embodiment 16, wherein Z is —OH.
18. The polymer P according to embodiment 17, wherein the at least one polyether of general formula A(a) is methoxypolyethylene glycol having a weight average molecular weight of 500 g/mol, according to DIN 55672-1.
19. The polymer P according to any of embodiments 1 to 18, wherein the at least one polyether of general formula A(b) is obtainable by reacting at least one polyether of general formula A(a) with at least one compound of formula (E), wherein R⁴ is 2-ethylhexyl, and X═O; and the molar ratio of the at least one polyether of general formula A(a) and the at least one compound of formula (E) is in the range from 1:0.8 to 12.
20. The polymer P according to any of embodiments 1 to 18, wherein the at least one polyether of general formula A(b) is obtainable by reacting at least one polyether of general formula A(a) with at least one compound of formula (E), wherein R⁴ is hexadecyl, and X═O; and the molar ratio of the at least one polyether of general formula A(a) and the at least one compound of formula (E) is in the range from 1:0.8 to 1:2.
21. The polymer P according to any of embodiments 1 to 20, wherein the at least one HALS of formula H1 is selected from 4-hydroxy-2,2,6,6-tetramethylpiperidinyloxyl, 4-amino-2,2,6,6-tetramethyl-piperidinyloxyl, 4-hydroxy-2,2,6,6-tetramethylpiperidine, 4-amino-2,2,6,6-tetramethyl-piperidine, 4-hydroxy-1,2,2,6,6-pentamethyl-piperidine, or 4-hydroxy-1-(2-hydroxyethyl)-2,2,6,6-tetramethylpiperidine.
22. The polymer P according to any of embodiments 1 to 21, wherein the at least one HALS H2 is a copolymer comprising dimethyl succinate polymer and 4-hydroxy-2,2,6,6-tetramethyl-1-piperidineethanol having a weight average molecular weight of 7000 g/mol according to DIN 55672-1.
23. The polymer P according to any of embodiments 1 to 22, wherein the at least one HALS of general formula H3 is

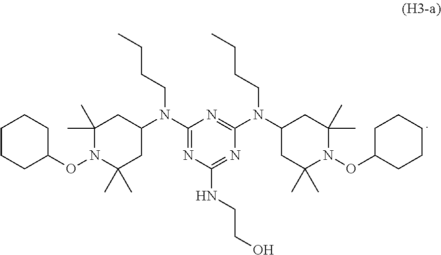

24. The polymer P according to any of embodiments 1 to 23, wherein the at least one HALS of general formula H4 is a diester selected from

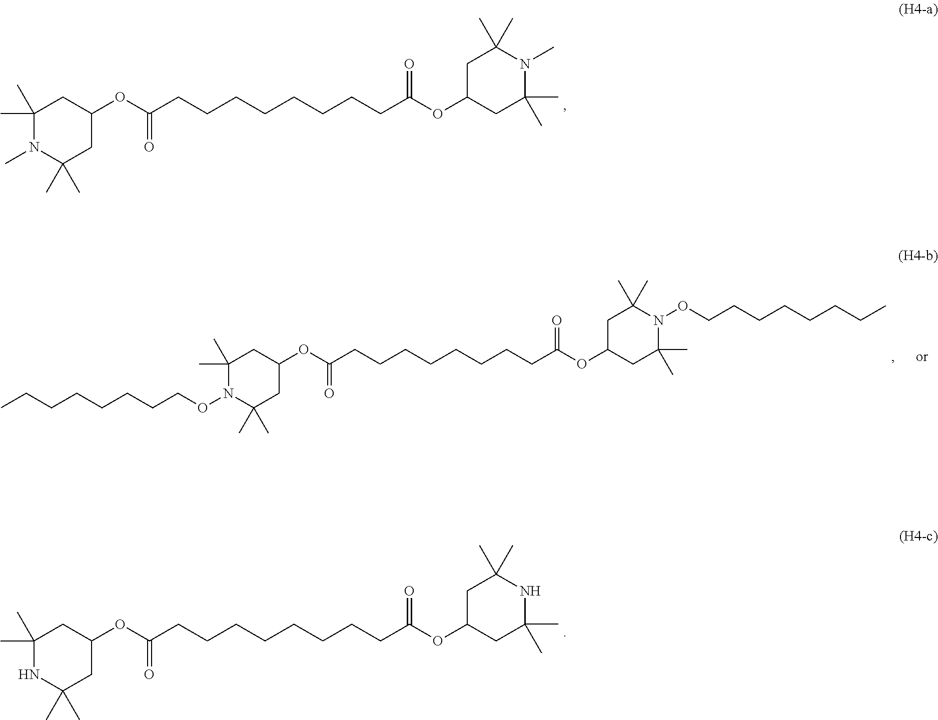

25. The polymer P according to any of embodiments 1 to 24, wherein the at least one HALS of formula H4 is a carbonate

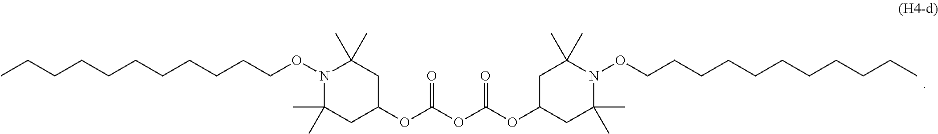 [SMILES: CCCCCCCCCCCON1C(C)(C)CC(OC(=O)OC(=O)OC2CC(C)(C)N(OCCCCCCCCCCC)C(C)(C)C2)CC1(C)C]

26. The polymer P according to any of embodiments 1 to 25, wherein the at least one HALS H5 is 1,5,8,12-tetrakis[4,6-bis(N-butyl-N-1,2,2,6,6-pentamethyl-4-piperidylamino)-1,3,5-triazin-2-yl]-1,5,8,12-tetraazadodecane.
27. The polymer P according to any of embodiments 1 to 26, wherein the at least one HALS H6 is tetrakis(1,2,2,6,6-pentamethyl-4-piperidyl)butane-1,2,3,4-tetracarboxylate.
28. The polymer P according to any of embodiments 1 to 27, wherein the at least one diester or polyester B1 is selected from dimethyl succinate, diethyl succinate, or 1,2-cyclohexandicarboxylic diisononylester.
29. The polymer P according to any of embodiments 1 to 28, wherein the at least one phthalic anhydride derivative B2 is trimelittic anhydride.
30. The polymer P according to any of embodiments 1 to 29, wherein the at least one diisocyanate or polyisocyanate B3 is selected from 2,4-toluene diisocyanate, 2,6-toluene diisocyanate, isophorondiisocyante, hexamethylene diisocyanate, or their dimer or trimer.
31. The polymer P according to any of embodiments 1 to 30, wherein the at least one epoxy polymer B4 comprises a monomer selected from trimethylolpropane triglycidyl ether, or bisphenol A diglycidyl ether.
32. The polymer P according to any of embodiments 1 to 31, wherein the at least one maleic anhydride polymer B5 is styrene maleic anhydride copolymer.
33. The polymer P according to any of embodiments 1 to 32 having a weight average molecular weight in the range of 200 g/mol to 100,000 g/mol according to DIN 55672-1.
34. The polymer P according to any of embodiments 1 to 33 having a weight average molecular weight in the range of 500 g/mol to 50,000 g/mol according to DIN 55672-1.
35. The polymer P according to any of embodiments 1 to 34 having a weight average molecular weight in the range of 2000 g/mol to 50,000 g/mol according to DIN 55672-1.
36. The polymer P according to any of embodiments 1 to 35 having a polydispersity index in the range of 1.1 to 4.0 according to according to DIN 55672-1.
37. The polymer P according to any of embodiments 1 to 36 having a HALS content from 0.1 to 3.5 mmol HASL/g.
38. The polymer P according to any of embodiments 1 to 37 having HALS content from 0.2 to 3.0 mmol HASL/g.
39. A method for preparing the polymer P according to any of embodiments 1 to 38 comprising
   i. mixing the at least one polyether A and the at least one hindered amine light stabilizer H selected from H2, H4, H6, or mixtures thereof; and
   ii. heating the mixture obtained in step (i) at 80° C. to 200° C.
40. The method according to embodiment 39 further comprises adding at least one catalyst selected from tetrabutyl titanate, or dibutyltin dilaurate to the mixture obtained in step (i).
41. The method according to embodiment 40, wherein the amount of the at least one catalyst is in the range of 0.1 to 5.0 wt. % based on the total amount of the reaction mixture.
42. The method according to embodiment 40 or 41, wherein the amount of the at least one catalyst is in the range of 0.25 to 1.0 wt. % based on the total amount of the reaction mixture.
43. A method for preparing the polymer P according to any of embodiments 1 to 38 comprising
   i. mixing the at least one polyether A, the at least one hindered amine light stabilizer H selected from H1, H2, H3, H4, H5, H6, or mixtures thereof, and the at least one compound B selected from B1, B2, or B5; and
   ii. heating the mixture obtained in step (i) at 80° C. to 200° C.
44. The method according to embodiment 43 further comprises adding at least one catalyst selected from tetrabutyl titanate, or dibutyltin dilaurate to the mixture obtained in step (i).
45. The method according to embodiment 44, wherein the amount of the at least one catalyst is in in the range of 0.1 to 5.0 wt. % based on the total amount of the reaction mixture.
46. The method according to any of embodiments 43 to 45, wherein the amount of the at least one catalyst is in in the range of 0.25 to 1.0 wt. % based on the total amount of the reaction mixture.
47. A method for preparing the polymer P according to any of embodiments 1 to 38 comprising
   (i) reacting the at least one polyether A and the at least one compound B selected from B3 or B4; and
   (ii) reacting the product obtained in step (i) with the at least one hindered amine light stabilizer H selected from H1, H2, H3, H4, H5, H6, or mixtures thereof.
48. The method according to embodiment 47 further comprising adding at least one solvent in step (i); wherein the at least one solvent is selected from ethyl acetate, or methoxypropyl acetate.
49. The method according to embodiment 47 or 48 further comprises adding at least one catalyst in an amount in the range of 0.1 to 5.0 wt. % based on the total amount of the reaction mixture.
50. The method according to embodiment 49, wherein the at least one catalyst is selected from aluminum trichloride.
51. The method according to any of embodiments 47 to 50, wherein step (i) is carried out at 40° C. to 120° C.
52. The method according to any of embodiments 47 to 51, wherein step (ii) is carried out at 50° C. to 200° C.
53. A liquid composition comprising the polymer P according to any of embodiments 1 to 38.
54. A liquid composition in the form of a dispersion comprising at least one fine particulate solid material and the at least one polymer P according to any of embodiments 1 to 38.
55. The liquid composition according to embodiment 54, wherein the at least one fine particulate solid material has a particle size Do in the range of 0.005 um to 100 um, according to dynamic light scattering technique with a fixed scattering angle of 90° or 180°.
56. The liquid composition according to any of embodiments 54 or 55, wherein the at least one fine particulate solid material is at least one pigment.
57. The liquid composition according to any of embodiments 54 to 56 further comprising at least one additive selected from filler, binder, wetting agent, rheology modifier, UV filter, defoamer, leveling agent, slip agent, substrate wetting agent, antioxidant, radical scavenger, biocide, or coalescing agent.
58. The liquid composition according to any of embodiments 54 to 57 in the form of a pigment paste, a millbase, a colorant, a coating composition, or an ink.
59. A coating composition comprising
   i. the polymer P according to any of embodiments 1 to 38;
   ii. at least one particulate solid material selected from pigments, fillers, or mixtures thereof;
   iii. at least one liquid diluent, and
   iv. at least one polymeric binder
wherein the at least one particulate solid material is dispersed in a liquid diluent selected from organic solvents, water, reactive diluents, or mixture thereof.
60. The coating composition according to embodiment 59 comprising
   i. 0.1 to 50 wt. % based on the total weight of the liquid composition, of the polymer according to any of embodiments 1 to 38;
   ii. 1 to 70 wt. % based on the total weight of the coating composition, of the at least one fine particulate solid material;
   iii. 10 to 98 wt. % based on the total weight of the liquid composition, of the at least one liquid diluent; and
   iv. 10 to 98 wt. % based on the total weight of the liquid composition, of the at least one binder.
61. Use of the polymer P according to any of embodiments 1 to 38 as a dispersant.
62. Use of the polymer P according to any of embodiments 1 to 38 as a light stabilizer.
63. Use of the polymer P according to any of embodiments 1 to 38 in a coating composition.

While the presently claimed invention has been described in terms of its specific embodiments, certain modifications and equivalents will be apparent to those skilled in the art and are intended to be included within the scope of the presently claimed invention.

### EXAMPLES

The presently claimed invention is illustrated in detail by non-restrictive working examples which follow. More particularly, the test methods specified hereinafter are part of the general disclosure of the application and are not restricted to the specific working examples.

### Materials

The following materials are used in the Examples:

| | |
|---|---|
| Pluriol ®A520E | is a polyether (methylpolyethylene glycol) having MW of 500 g/mol, |
| Irgazin ® Red L 3670 HD | is an organic pigment, |
| Foamstar ® SI 2250 | is a defoamer for various water-based coating systems and pigment |
| | concentrates, |
| Foamaster ® 8034 | is a defoamer for emulsion paints, |
| Dispex ® CX4320 | is a polymeric dispersing agent for inorganic fillers and pigments, |
| Acronal ® A754 | is an aqueous dispersion of a straight acrylic copolymer, and |
| Rheovis ® PU1216 | is a non-ionic medium pseudoplastic rheology modifier for water-based |
| | coatings are available from BASF Se. |

Desmodur® ultra IL BA is an aromatic polyisocyanate based on toluene diisocyanate, and
Desmodur® ultra T100 is 2,4-toluene diisocyanate,
are available from Coverstro.

| | |
|---|---|
| Jeffamine ®M-2070 | is a propylene oxide/ethylene oxide (PO/EO) copolymer based polyetheramine |
| | with an weight average molecular weight of about 2,000. The |
| | PO/EO mol ratio is 10/31. |
| Erisys ® GE-30 | is a low viscosity high epoxy functional resin, |
| | are available from Hunstman Corporation. |
| SMA ®1000P | is a low MW of poly(styrene-co-maleic anhydride) resin, and |
| SMA ®2000P | is a low MW of poly(styrene-co-maleic anhydride) resin, |
| | are available from Cray Valley. |
| ADK STAB LA-81 | is bis(1-undecanoxy-2,2,6,6-tetramethylpiperidin-4-yl)carbonate, and |
| ADK STAB LA-52 | is tetrakis(1,2,2,6,6-pentamethyl-4-piperidyl) butane-1,2,3,4-tetracarboxylate |
| | are available from Adeka Polymer Additives. |
| Bentone ® LT | is a rheological additive, an organically modified refined hectorite clay |
| | based thickener for waterborne paints and aqueous coating, and |
| Finntalc M15 | is floated, medium sized, laminar talc (Mg-silicate), |
| | is available from Elementis specialities. |
| Minex ® 10 | is a specialty mineral is a micronized functional filler and extender |
| | available from Sibelco speciality minerals. |
| Calgon ® N | is a dispersing agent for emulsion paints, plasters and adhesives |
| | available from ICL Phosphate Specialty. |
| Silres ® BS 1306 | is a solventless, water-thinnable emulsion of a polysiloxane modified with |
| | functional silicone resin available from Wacker Chemie AG. |

Dimethyl succinate, trimellitic anhydride, 4-hydroxy-2,2,6,6-tetramethylpiperidinyloxyl, 4-amino-2,2,6,6-tetramethylpiperidinyloxyl, 4-Hydroxy-2,2,6,6-tetramethylpiperidine, 4-amino-2,2,6,6-tetramethylpiperidine, 4-hydroxy-1,2,2,6,6-pentamethyl-piperidine, 4-hydroxy-1-(2-hydroxyethyl)-2,2,6,6-tetramethylpiperidine, 4-hydroxy-1-(2-hydroxyethyl)-2,2,6,6-tetramethylpiperidine, 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane were available from Sigma Aldrich.

### Methods

Epoxy content: The epoxy content was determined according to DIN EN ISO 7142.
Molecular weight: The weight average molecular weight (M_{w}), number average molecular weight (Mₙ), and polydispersity index (PDI) were determined according to DIN 55672-1. The weight average molecular weight and the number average molecular weight of the polymer are determined by gel permeation chromatography (GPC) using THE as eluent (1 mL/min) and using polystyrene as a standard resin according to DIN 55672-1.
Acid number: The acid number was determined according to DIN 53402:1990-09.
NCO number: The NCO number was determined according to DIN 53185.
HALS content: The HALS content is calculated based on eq (mmol) HALS molecular per gram solid polymer.
Viscosity: Viscosity was determined by analogy to DIN 53019-1:2008-09, using a Thermo-Haake RheoStress 600 equipment under the CR mode at 22° C. and a shear rate of 1 sec⁻¹ (Spindle CP50).
Delta E: Delta E was determined according to DIN EN ISO 16474-2, cycle-No. 1 (2014).

### A) Polyether A—Polyether (a) and Polyether A(b)

Polyethers A1 and A2 were commercially available.

Polyether A1 was Jeffamine® M2070, and Polyether A2 was Pluriol® A520E. Polyethers A3-A5 were synthesized.

### Preparation of Polyethers A3-A5

### Example 1: Preparation of Polyether A3

In a reaction vessel maintained under nitrogen atmosphere, were charged Intermediate A1 (50 g. 25 mmol) and 2-ethylhexyl glycidyl ether (4.5 g. 24 mmol) and the reaction mixture was heated at 170° C. until the epoxy content of the mixture was zero. The product was cooled to room temperature to obtain intermediate A3 as a yellowish liquid, having M, of 2,500 g/mol, PDI of 1.1.

### Example 2: Preparation of Polyether A4

In a reaction vessel maintained under nitrogen atmosphere, were charged Intermediate A1 (50 g, 25 mmol) and glycidyl hexadecyl ether (7.5 g, 25 mmol), and the reaction mixture was heated at 170° C. until the epoxy content of the mixture was zero. The product was cooled to room temperature to obtain intermediate A4 as a yellowish liquid, having M_{W} of 2,600 g/mol, PDI of 1.1.

### Example 3: Preparation of Polyether A5

In a 2 L autoclave equipped with a heating system, cooling coil, agitator, connection to vacuum pump and connection for ethylene oxide or propylene oxide tanks, were charged Intermediate A2 (150 g.) and potassium-tert-butoxide (KOBu) (2 g.), followed by purging the autoclave with nitrogen. The content of the autoclave was heated to 110° C. and the content dehydrated under a reduced pressure of 10 mbar for 1 h. The resultant was heated to 120° C., and ethylene oxide (300 g.) was introduced in the autoclave under pressure over 12 h. The reaction mixture was heated at this temperature until the pressure lowered and became constant. The temperature of the reaction mixture was then increased to 130° C., and 200 g propylene oxide was introduced into the autoclave under pressure over 12 h. The reaction mixture was heated at this temperature until the pressure lowered and became constant. All volatile by-products and residual monomers were removed under reduced pressure to obtain 640 g of the intermediate A5.

The M_{w} of Intermediate A5 was 1950 g/mol, and PDI of 1.3.

B) Compound B—compounds B1 to B7
[having at least one functional group selected from ester, isocyanate, anhydride, carboxylic acid, and epoxide]
Compounds B1 to B7 were commercially available compounds.
Compound B1—a was dimethyl succinate,
Compound B2—a was trimellitic anhydride,
Compound B3—a was Desmodour® IL BA, an aromatic polyisocyanate based on toluene diisocyanate.
Compound B3—b was 2,4-toluene diisocyanate,
Compound B4—a was a low viscosity high epoxy functional resin, and
Compound B5—a and Compound B5-b were low MW poly(styrene-co-maleic anhydride) resins.

### C) Hindered Amine Light Stabilizers (HALS) H

The following hindered amine light stabilizer (HALS) were commercially available.

### i) Hindered Amine Light Stabilizers (HALS) of General Formula H1

HALS H1-a to HALS H1-f were as follows:

| Code | Compound |
|---|---|
| H1-a | 4-Hydroxy-2,2,6,6-tetramethylpiperidinyloxyl |
| H1-b | 4-Amino-2,2,6,6-tetramethylpiperidinyloxyl |
| H1-c | 4-Hydroxy-2,2,6,6-tetramethylpiperidine |
| H1-d | 4-Amino-2,2,6,6-tetramethylpiperidin |
| H1-e | 4-Hydroxy-1,2,2,6,6-pentamethyl-piperidin |
| H1-f | 4-Hydroxy-1-(2-hydroxyethyl)-2,2,6,6-tetramethylpiperidine |

### ii) Hindered Amine Light Stabilizers (HALS) Copolymer H2

HALS H2—a was a copolymer dimethyl succinate and 4-hydroxy-2,2,6,6-tetramethyl-1-piperidine ethanol having Mₙ=3500.

| Code | Compound |
|---|---|
| H2-a | Copolymer dimethyl succinate and 4-hydroxy-2,2,6,6- |
| | tetramethyl-1-piperidine ethanol having Mₙ = 3500 |

iii) Hindered Amine Light Stabilizers (HALS)—Triazine Based Dimer Having NH or OH-Functionality H3

HALS H3-a was 2,4-bis[N-Butyl-N-(1-cyclohexyloxy-2,2,6,6-tetramethylpiperidin-4-yl)amino]-6-(2-hydroxyethylamine)-1,3,5-triazine.

| Code | Comopund |
|---|---|
| H3-a | 2,4-bis [N-Butyl-N-(1-cyclohexyloxy-2,2,6,6- |
| | tetramethylpiperidin-4-yl) amino]-6-(2- |
| | hydroxyethylamine)-1,3,5-triazine |

### iv) Hindered Amine Light Stabilizers (HALS) of General Formula H4

HALS H4-a to HALS H4-d were as follows:

| Code | Comopund |
|---|---|
| H4-a | Bis(1,2,2,6,6-pentamethyl-4-piperidyl) sebacate |
| H4-b | Bis(1-octyloxy-2,2,6,6-tetramethyl-4-piperidyl)sebacate |
| H4-c | bis(2,2,6,6-tetramethyl-4-piperidyl)sebacate |
| H4-d | Bis(1-undecanoxy-2,2,6,6-tetramethylpiperidin-4-yl)carbonate |

### v) Hindered Amine Light Stabilizer (HALS) H5-Triazine Substituted Alkylamine-Based Oligomer Having NH-Functionality

HALS-H5-a was 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane

### vi) Hindered Amine Light Stabilizer (HALS) H6-Polyol Polyester

HALS H6-a was tetrakis(1,2,2,6,6-pentamethyl-4-piperidyl) butane-1,2,3,4-tetracarboxylate.

### Polymer (P) Synthesis

### Example 1: Preparation of Polymer P1

### Polymer 1:

To a reaction vessel maintained under nitrogen atmosphere, were added Intermediate A1 (65 g), Intermediate B1-a (15 g), and Intermediate H1-f (20 g). The reaction mixture was heated at 120° C. for 1 h. Tetrabutyl titanate (0.5 g) was added to the resultant mixture, followed by heating at 150° C. under reduced pressure until no distillate formed. The product was cooled to obtain polymer P1 having M, of 4,500 g/mol, PDI of 1.9. HALS content: 1.0 mmolHALS/g polymer.

### Polymer 2-10

Polymers 2-10 were prepared by a process similar to the process of preparation of polymer 1. The starting materials and their amount are provided in Table 1.

TABLE 1
Polymer 2-10

| | | | | | | HALS |
|---|---|---|---|---|---|---|
| | Poly- | | | | | content |
| Polymer | ether A | Compound B | HALS H | Mw | PDI | (mmol/g) |
| 2 | A1, 30 g | B1-a, 30 g | H1-f, 40 g | 8000 | 2.1 | 2.0 |
| 3 | A3, 40 g | B1-a, 25 g | H1-f, 35 g | 9500 | 1.8 | 1.8 |
| 4 | A4, 30 g | B1-a, 30 g | H1-f, 40 g | 9700 | 2.0 | 2.0 |
| 5 | A5, 20 g | B1-a, 35 g | H1-f, 45 g | 7500 | 2.3 | 2.3 |
| 6 | A3, 30 g | B1-a, 40 g | H1-b, 30 g | 6500 | 1.7 | 1.7 |
| 7 | A4, 30 g | B1-a, 40 g | H1-d, 30 g | 7100 | 1.8 | 1.7 |
| 8 | A3, 30 g | B1-a, 30 g | H3-a, 40 g | 6400 | 2.0 | 1.0 |
| 9 | A4, 30 g | B1-a, 20 g | H5-a, 50 g | 6700 | 1.9 | 1.8 |
| 10 | A5, 30 g | B1-a, 20 g | H5-a, 50 g | 5500 | 1.7 | 1.8 |

### Polymer 11:

To a reaction vessel maintained under nitrogen atmosphere, were added Intermediate A2 (60 g), Intermediate B2-a (20 g), and Intermediate H1-f (20 g) and the mixture was heated at 120° C. for 1 h. Tetrabutyl titanate (0.5 g) was added to the reaction mixture, followed by heating at 170° C. under reduced pressure until the acid number of the reaction mixture reached a stable value, i.e., the acid number remained constant. The reaction mixture was cooled to obtain polymer P11 having M_{w} of 7,300 g/mol, PDI of 1.7. HALS content: 10.0 mmolHALS/g polymer.

### Polymer 12-14

Polymers 12-14 were prepared by a process similar to the process for preparation of polymer 11. The starting materials and their respective amounts are provided in Table 2.

TABLE 2
Polymer 12-14

| | | | | | | HALS |
|---|---|---|---|---|---|---|
| | Poly- | | | | | content |
| Polymer | ether A | Compound B | HALS H | Mw | PDI | (mmol/g) |
| 12 | A3, 55 g | B2-a, 15 g | H1-a, 30 g | 8500 | 1.8 | 1.7 |
| 13 | A4, 55 g | B2-a, 15 g | H1-c, 30 g | 9100 | 1.6 | 1.7 |
| 14 | A3, 55 g | B2-a, 15 g | H1-e, 30 g | 8700 | 1.7 | 1.7 |

### Polymer 15:

To a reaction vessel maintained under nitrogen atmosphere, were added ethyl acetate (50 g) and Intermediate B3-a (65 g) and stirred at 30° C. Intermediate A1 (50 g) was slowly added to the reaction vessel and the reaction mixture was heated at 40° C. for 3 h. Intermediate H1-f (20 g) was slowly added to the reaction mixture and the resultant mixture was stirred at 60° C. until the NCO number of the reaction mixture was zero. The volatiles were removed at 130° C. under reduced pressure to obtain polymer 15 having a M_{w} of 9,700 g/mol, PDI of 1.6. HALS content: 1.0 mmolHALS/g polymer.

### Polymer 16-21

Polymers 16-21 were prepared by a process similar to the process for preparation of polymer 15. The starting materials and their respective amounts are provided in Table 3.

TABLE 3
Polymer 16-21

| | | | | | | HALS |
|---|---|---|---|---|---|---|
| | | | | | | content |
| | Poly- | Com- | | | | (mmol/ |
| Polymer | ether A | pound B | HALS H | Mw | PDI | g) |
| 16 | A2, 30 g | B3-a, 65 g | H1-a, 7 g | 5500 | 1.5 | 0.6 |
| 17 | A5, 50 g | B3-a, 65 g | H1-c, 25 g | 9,400 | 1.6 | 1.3 |
| 18 | A1, 50 g | B3-a, 65 g | H3-a, 60 g | 10,700 | 1.5 | 0.6 |
| 19 | A1, 50 g | B3-b, 4.5 g | H1-a, 4 g | 2,500 | 1.3 | 0.4 |
| 20 | A2, 50 g | B3-b, 17 g | H1-c, 17 g | 1,200 | 1.4 | 1.2 |
| 21 | A5, 50 g | B3-b, 4.5 g | H3-a, 15 g | 2,800 | 1.5 | 0.6 |

### Polymer 22:

To a reaction vessel maintained under nitrogen atmosphere, was added Intermediate B4-a (14 g) and stirred at 50° C. Intermediate A1 (65 g) and AlCl₃ (0.1 g) were slowly added to the reaction vessel and the mixture was heated at 100° C. for 5 h. Intermediate H1-b (6 g) was slowly added to the reaction mixture, and it was heated at 170° C. until the epoxy content of the reaction mixture was zero. The obtained polymer 22 had a M_{w} of 6,700 g/mol, PDI of 1.4. HALS content: 0.4 mmolHALS/g polymer.

### Polymer 23-26

Polymers 23-26 were prepared by a process similar to the process for preparation of polymer 22. The starting materials and their respective amounts are provided in Table 4.

TABLE 4
Polymer 23-26

| | | | | | | HALS |
|---|---|---|---|---|---|---|
| | Poly- | Com- | | | | content |
| Polymer | ether A | pound B | HALS H | Mw | PDI | (mmol/g) |
| 23 | A2, 20 g | B4-a, 14 g | H1-d, 4 g | 5500 | 1.5 | 0.6 |
| 24 | A3, 65 g | B4-a, 14 g | H1-b, 5 g | 12,500 | 2.2 | 0.3 |
| 25 | A5, 65 g | B4-a, 14 g | H1-d, 6 g | 10,700 | 2.4 | 0.4 |
| 26 | A1, 65 g | B4-a, 14 g | H5-a, 20 g | 13,000 | 2.3 | 0.7 |

### Polymer 27:

To a reaction vessel maintained under nitrogen atmosphere, was added solvent methoxypropyl acetate (15 g) and Intermediate B5-a (10 g) and the mixture was stirred until homogenous. Intermediate A1 (50 g) and Intermediate H1-b (3.5 g) were added to the reaction vessel and the resultant mixture was heated at 170° C. under reduced pressure until the acid number was stable, i.e., acid number did not change. The obtained polymer 27 had a M_{w} of 22,500 g/mol, PDI of 2.5. HALS content: 0.3 mmo (HALS/g polymer.

### Polymer 28-30

Polymers 28-30 were prepared by a process similar to the process for preparation of polymer 27. The starting materials and their respective amounts are provided in Table 5.

TABLE 5
Polymer 28-30

| | | | | | | HALS |
|---|---|---|---|---|---|---|
| | | | | | | content |
| | Poly- | Com- | | | | (mmol/ |
| Polymer | ether A | pound B | HALS H | Mw | PDI | g) |
| 28 | A1, 30 g | B5-a, 10 g | H1-b, 6 g | 17,500 | 2.2 | 0.7 |
| 29 | A1, 70 g | B5-a, 10 g | H1-d, 2.5 g | 29,500 | 2.8 | 0.2 |
| 30 | A1, 40 g | B5-b, 15 g | H1-b, 5 g | 23,700 | 2.5 | 0.5 |

### Polymer 31:

To a reaction vessel maintained under nitrogen atmosphere, was added Intermediate A1 (50 g) and Intermediate H2-a (50 g) and the mixture was heated to 120° C. Tetrabutyl titanate (0.5 g) was added to the mixture and the resultant mixture was heated at 170° C. for 30 h to obtain polymer 31 having the M_{w} of 8,900 g/mol, P0 of 2.9. HALS content: 1.8 mmoHALS/g polymer.

### Polymer 32-49

Polymers 32-49 were prepared by a process similar to the process for preparation of polymer 31. The starting materials and their respective amounts are provided in Table 6.

TABLE 6
Polymer 32-49

| | | | | | HALS |
|---|---|---|---|---|---|
| | | Compound B | | | content |
| Polymer | Polyether A | and HALS H | Mw | PDI | (mmol/g) |
| 32 | A1, 30 g | H2-a, 70 g | 9,500 | 2.5 | 2.5 |
| 33 | A2, 50 g | H2-a, 50 g | 1,600 | 2.1 | 1.8 |
| 34 | A2, 30 g | H2-a, 70 g | 3,300 | 2.6 | 2.5 |
| 35 | A3, 50 g | B1-a, 2.1 g | 13,500 | 2.4 | 1.8 |
| | | H2-a, 50 g | | | |
| 36 | A4, 30 g | H2-a, 70 g | 14,000 | 2.2 | 2.5 |
| 37 | A5, 50 g | H2-a, 50 g | 9,500 | 3.0 | 1.8 |
| 38 | A3, 50 g | B1-a 3.6 g, | 10,500 | 2.8 | 2.0 |
| | | H4-a, 50 g | | | |
| 39 | A4, 30 g | B1-a 2.2 g, | 11,400 | 2.7 | 2.8 |
| | | H4-a, 70 g | | | |
| 40 | A3, 30 g | B1-a 2.2 g, | 9,700 | 3.1 | 1.9 |
| | | H4-b, 70 g | | | |
| 41 | A4, 50 g | B1-a 3.6 g, | 10,200 | 2.6 | 1.4 |
| | | H4-b, 50 g | | | |
| 42 | A3, 30 g | B1-a, 2.1 g | 13,800 | 2.8 | 2.8 |
| | | H4-c, 70 g | | | |
| 43 | A4, 30 g | B1-a, 2.1 g | 12,500 | 2.8 | 2.8 |
| | | H4-c, 70 g | | | |
| 44 | A3, 30 g | B1-a, 2.1 g | 11,700 | 2.7 | 2.0 |
| | | H4-d, 70 g | | | |
| 45 | A4, 50 g | B1-a, 3.6 g | 15,600 | 3.0 | 2.4 |
| | | H6-a, 50 g | | | |
| 46 | A3, 30 g | B1-a, 3.0 g | 5,100 | 4.0 | 2.4 |
| | | H2-a, 50 g | | | |
| | | H4-a, 17 g | | | |
| 47 | A3, 30 g | B1-a, 3.0 g | 8.800 | 2.0 | 2.3 |
| | | H2-a, 60 g | | | |
| | | H4-b, 7 g | | | |
| 48 | A3, 30 g | B1-a, 3.0 g | 5.500 | 2.0 | 2.1 |
| | | H2-a, 40 g | | | |
| | | H4-b, 27 g | | | |
| 49 | A3, 30 g | B1-a, 3.0 g | 4.100 | 2.0 | 2.3 |
| | | H2-a, 33 g | | | |
| | | H4-a, 17 g | | | |
| | | H4-b, 17 g | | | |

### Application Test

### A) Aqueous Solution of Polymer P

To evaluate the dispersant effect of the obtained polymer P, a concentrated aqueous solution was prepared using the polymer P.

To prepare the aqueous solution, the polymer P (40 g) was charged into a reactor and warmed to 90° C. under stirring followed by slow addition of warm water (60 g). The resultant aqueous solution was stirred for 3 h.

### B) Millbase Preparation

The resin free pigment concentrate (millbase) was prepared with polymer P.

The components of the millbase are provided below in Formulation 1. These components of formulation 1 were dispersed in a Scandex Shaker for 4 h with the help of glass beads. Afterwards the millbase was filtered and stored at room temperature overnight.

### Formulation 1: Water-Based Pigment Concentrates

| Sr. | Component | Amount | |
|---|---|---|---|
| 1) | Dispersant (40% active in water) | 19 | g |
| 2) | Water | 50 | g |
| 3) | Irgazin ® Red L 3670 HD | 30 | g |
| 4) | NaOH (25%) | 0.3 | g |
| 5) | Foamstar ® SI 2250 | 0.7 | g |
| 6) | 2.0 mm glass beads | 200 | g |
| | Total | 100 | g |

The performance of the dispersants was found to be generally very good with a low millbase viscosity.

Table 7 shows the data for viscosity of the millbase after 24 hours at room temperature and after 14 days at 50° C.

TABLE 7
Viscosity of millbase before and after storage

| | | Viscosity (mpas@1/s) | |
|---|---|---|---|
| Millbase | Dispersant | 24 h RT | 14 day@50° C. |
| MB Comp. 1 | Control - No dispersant | No paste obtained | |
| MB Comp. 2 | Control - Dispex Ultra PX4290 | 90 | 90 |
| MB1 | Polymer 1 | 130 | 2500 |
| MB2 | Polymer 6 | 170 | 1300 |
| MB3 | Polymer 10 | 200 | 1800 |
| MB4 | Polymer 15 | 90 | 80 |
| MB5 | Polymer 20 | 80 | 1300 |
| MB6 | Polymer 26 | 150 | 250 |
| MB7 | Polymer 28 | 100 | 130 |
| MB8 | Polymer 32 | 130 | 500 |
| MB9 | Polymer 36 | 80 | 600 |
| MB10 | Polymer 39 | 110 | 560 |
| MB11 | Polymer 44 | 150 | 750 |
| MB12 | Polymer 48 | 70 | 80 |
| MB13 | Polymer 49 | 90 | 100 |

### C) Coating Composition

Coating composition was prepared by mixing the millbase with a let-down composition. The letdown formulation is shown in Table 8.

A millbase (MB) (20 g) of from examples showed in Table 7 were stirred into 80 g Let-down formulation using Dispermat 5 min@1000 rpm.

TABLE 8
let down formulation

| Sr. | Component | Amount | |
|---|---|---|---|
| 1) | Water | 230 | g |
| 2) | Bentone ® LT (Thickener) | 3.2 | g |
| 3) | Dispex ® CX4320 | 4.4 | g |
| 4) | Calgon ® N 25% | 3.2 | g |
| 5) | Foamaster ® 8034 | 3.2 | g |
| 6) | Finntalc M15 | 149 | g |
| 7) | Minex ® 10 | 245 | g |
| | Dispermat 20 | | |
| | min@3000 rpm) | | |
| 8) | Acronal ® A754 | 290 | g |
| 9) | Silres ® BS 1306 | 33 | g |
| 10) | Butyldiglycol | 27 | g |
| 11) | Rheovis ® PU1216 | 12 | g |
| | total | 1000 | g |

### D) Results

The coating composition was applied onto cold rolled steel panels with a 250 pm application bar. Each sample was applied onto 3 panels. The wet films were allowed to stand at room temperature for 7 days.

The artificial weathering and artificial radiation of the dried films was evaluated according to DIN EN ISO 16474-2, cycle-No. 1 (2014). The results are shown in Table 9.

The weathering test results (delta E) clearly showed that the coating compositions containing dispersants containing HALS group exhibited a good weather stability property.

TABLE 9
Artificial weathering test

| Film | | Delta E | |
|---|---|---|---|
| based on | Dispersant | 1000 h | 2000 h |
| MB Comp. 2 | Control---Dispex Ultra PX4290 | 2.0 | 12.0 |
| MB1 | Polymer 1 | 2.1 | 8.3 |
| MB2 | Polymer 6 | 1.5 | 7.3 |
| MB3 | Polymer 10 | 2.0 | 7.5 |
| MB4 | Polymer 15 | 1.9 | 10 |
| MB5 | Polymer 20 | 2.2 | 8.0 |
| MB6 | Polymer 26 | 1.4 | 10.0 |
| MB7 | Polymer 28 | 1.7 | 9.0 |
| MB8 | Polymer 32 | 1.8 | 4.1 |
| MB9 | Polymer 36 | 1.5 | 4.0 |
| MB10 | Polymer 39 | 1.4 | 3.5 |
| MB11 | Polymer 44 | 1.3 | 8.4 |
| MB12 | Polymer 48 | 1.8 | 3.0 |
| MB13 | Polymer 49 | 1.5 | 2.5 |

1.-29. (canceled)

30. A polymer P obtained by reacting:
at least one polyether A;
at least one hindered amine light stabilizer (HALS) H selected from H1, H2, H3, H4, H5, H6, or mixtures thereof, and
at least one compound B having at least one functional group selected from the group consisting of ester, isocyanate, anhydride, carboxylic acid, or epoxide, and the at least one compound B is selected from B1, B2, B3, B4, B5, or mixtures thereof,
or
at least one polyether A; and
at least one hindered amine light stabilizer selected from H2, H4, H6, or mixtures thereof;
wherein,
the at least one polyether A is selected from at least one polyether of general formula A(a), at least one polyether of general formula A(b), or mixtures thereof;
wherein
(a) the at least one polyether of general formula A(a) is 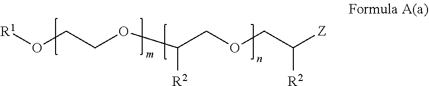
wherein
R¹ is selected from linear or branched, substituted or unsubstituted C₁-C₂₂ alkyl, linear or branched, substituted or unsubstituted C₁-C₂₂ alkylenyl, substituted or unsubstituted C₆-C₁₅ alkylaryl, or substituted or unsubstituted C₆-C₁₄ aryl,
R² is selected from linear or branched, substituted or unsubstituted C₁-C₄ alkyl;
m is an integer in range of 1 to 100;
n is an integer in range of 0 to 100;
m units and n units are distributed to form a random copolymer or a block copolymer or a gradient copolymer; and
Z is selected from —OH, —NH₂, or —NHR³, wherein R³ is selected from linear or branched, substituted or unsubstituted C₁-C₂₂ alkyl;
and
(b) the at least one polyether of general formula A(b) is obtainable by reacting at least one polyether of general formula A(a) 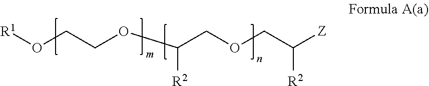
wherein
R¹, R², m, n, and Z are as defined above;
with at least one compound of formula (E) 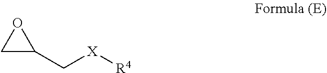
wherein,
R⁴ is selected from linear or branched, substituted or unsubstituted C₁-C₂₂ alkyl, linear or branched, substituted or unsubstituted C₁-C₂₂ alkylenyl, substituted or unsubstituted C₆-C₁₅ alkylaryl, or substituted or unsubstituted C₆-C₁₄ aryl, and
X is selected from O, S or CH₂;
and wherein the molar ratio of the at least one polyether of general formula A(a) and the at least one compound of formula (E) is in the range from 1:0.8 to 1:5;
and
wherein,
a) the hindered amine light stabilizer (HALS) of general formula H1 is 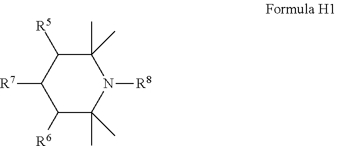
wherein
R⁵ and R⁶ are independently selected from H, or substituted or unsubstituted C₁₋₄ alkyl;
R⁷ is selected from —OH, —NH₂, —NHR⁹, —R¹⁰—OH, —R¹⁰—NH₂, or —R¹⁰—NHR⁹;
R⁸ is selected from —H, —O, linear or branched, substituted or unsubstituted C₁-C₂₂ alkyl, linear or branched, substituted or unsubstituted C₃-C₈ cycloalkyl, —OR¹¹, —R¹²—OH,— or —O—R¹²—OH;
wherein
R⁹, and R¹¹ are independently selected from linear or branched, substituted or unsubstituted C₁-C₂₂ alkyl; and
wherein
R¹⁰ and R¹² are independently selected from linear or branched, substituted or unsubstituted C₁-C₂₂ alkylene;
b) the hindered amine light stabilizer (HALS) H2 is a HALS copolymer comprising
(i) 4-hydroxy-2,2,6,6-tetramethyl-1-piperidineethanol; and
(ii) at least one dicarboxylic ester of general formula 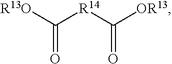
wherein,
R¹³ is selected from linear or branched, substituted or unsubstituted C₁-C₁₂ alkyl; and
R¹⁴ is selected from linear or branched, substituted or unsubstituted C₂-C₁₂ alkylene;
c) the hindered amine light stabilizer (HALS) of general formula H3 is a triazine based dimer having —NH or —OH-functionality 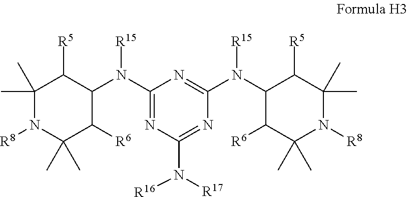
wherein,
R⁵, R⁶, and R⁸ are as defined above;
R¹⁵ is selected from H, or linear or branched, substituted or unsubstituted C₁-C₆ alkyl;
R¹⁶ is selected from H, or linear or branched, substituted or unsubstituted C₁-C₆ alkyl;
R¹⁷ is selected from —H, or —R¹⁸—OH, wherein R¹⁸ is selected from linear or branched, substituted or unsubstituted C₁-C₂₂ alkylene;
d) the hindered amine light stabilizer (HALS) of general formula H4 is a diester or carbonate functionalized HALS compound 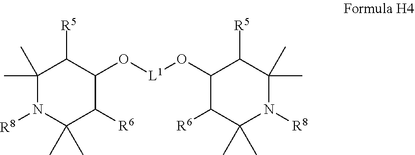
wherein,
R⁵, R⁶, and R⁸ are as defined above;
L₁ is 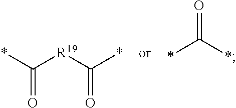
wherein
* indicates point of attachment to O, and
R¹⁹ is selected from linear or branched, substituted or unsubstituted C₁-C₂₂ alkylene;
e) the hindered amine light stabilizer (HALS) H5 is a triazine substituted alkylamine-based oligomer having NH-functionality 1,5,8,12-tetrakis[4,6-bis(Nbutyl-N-1,2,2,6,6-pentamethyl-4-piperidylamino)-1,3,5-triazin-2-yl]-1,5,8,12-tetraazadodecane;
f) the hindered amine light stabilizer (HALS) H6 is a polyol polyester tetrakis(1,2,2,6,6-pentamethyl-4-piperidyl) butane-1,2,3,4-tetracarboxylate; and
wherein,
B1 is at least one diester or polyester of general formula R²⁰(COOR²¹)_{q};
wherein
R²⁰ is selected from linear or branched, substituted or unsubstituted C₁-C₂₂-alkylene, or substituted or unsubstituted C₆-C₁₀ arylene;
R²¹ is selected from linear or branched, substituted or unsubstituted C₁-C₁₂-alkyl; and
q is an integer in the range of 2 to 5;
B2 is at least one phthalic anhydride derivative of general formula 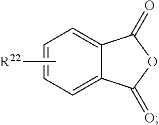
wherein
R²² is selected from 4-COOH, 4-NO₂, 4-F, 4-Cl, or 4-Br;
B3 is at least one a diisocyanate or polyisocyanate of general formula 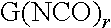
wherein,
G is selected from a linear or branched, substituted or unsubstituted C₂-C₂₂ alkyl, linear or branched, substituted or unsubstituted C₃-C₈ cycloalkyl, or substituted or unsubstituted C₆-C₁₄ arylene, and
r is 2 or 3 or 4;
B4 is at least one epoxy polymer; and
B5 is at least one maleic anhydride polymer.

31. The polymer P according to claim 30, wherein R¹ is selected from linear or branched, substituted or unsubstituted C₁-C₂₂ alkyl; m is an integer in the range of 1 to 50; and n is an integer in the range of 1 to 50.

32. The polymer P according to claim 30, wherein
m is an integer in range of 1 to 100; and
n is 0.

33. The polymer P according to claim 30, wherein the at least one polyether of general formula A(b) is obtained by reacting at least one polyether of general formula A(a) with at least one compound of formula (E), wherein R⁴ is 2-ethylhexyl, and X═O; and the molar ratio of the at least one polyether of general formula A(a) and the at least one compound of formula (E) is in the range from 1:0.8 to 1:2.

34. The polymer P according to claim 30, wherein the at least one polyether of general formula A(b) is obtained by reacting at least one polyether of general formula A(a) with at least one compound of formula (E), wherein R⁴ is hexadecyl, and X═O; and the molar ratio of the at least one polyether of general formula A(a) and the at least one compound of formula (E) is in the range from 1:0.8 to 1:2.

35. The polymer P according to claim 30, wherein the at least one HALS of formula H1 is selected from 4-hydroxy-2,2,6,6-tetramethylpiperidinyloxyl, 4-amino-2,2,6,6-tetramethylpiperidinyloxyl, 4-hydroxy-2,2,6,6-tetramethylpiperidine, 4-amino-2,2,6,6-tetramethylpiperidine, 4-hydroxy-1,2,2,6,6-pentamethyl-piperidine, or 4-hydroxy-1-(2-hydroxyethyl)-2,2,6,6-tetramethylpiperidine; and the at least one HALS H2 is a copolymer comprising dimethyl succinate polymer and 4-hydroxy-2,2,6,6-tetramethyl-1-piperidineethanol having a weight average molecular weight of 7000 g/mol according to DIN 55672-1.

36. The polymer P according to claim 30, wherein the at least one HALS of general formula H3 is

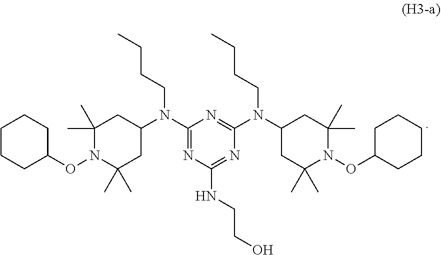

37. The polymer P according to claim 30, wherein the at least one HALS of general formula H4 is a diester selected from

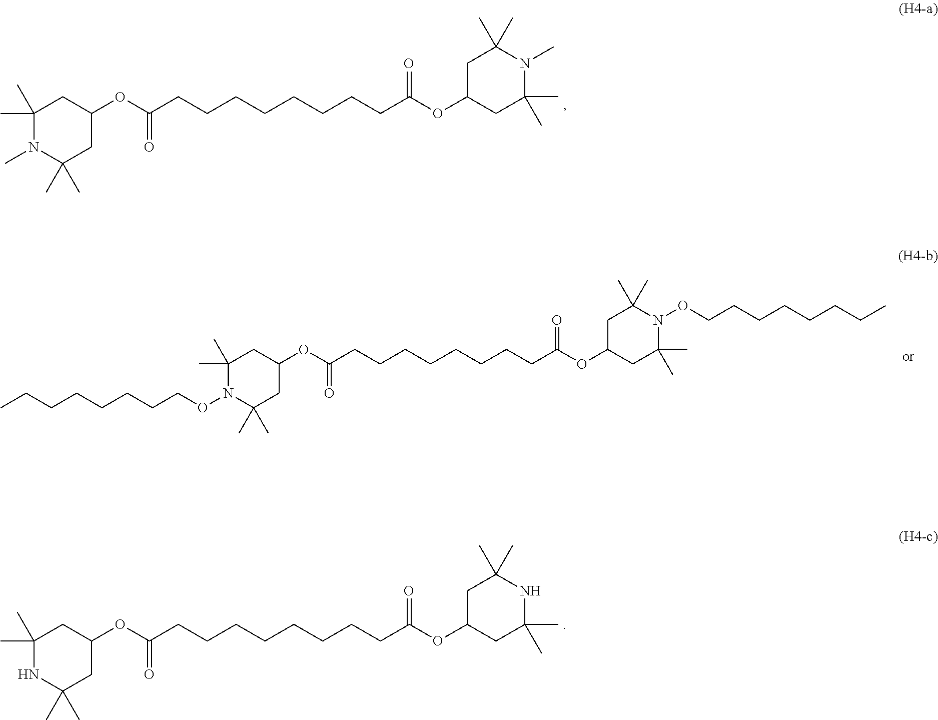

38. The polymer P according to claim 30, wherein the at least one HALS of formula H4 is a carbonate

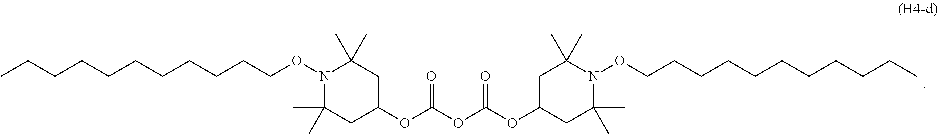 [SMILES: CCCCCCCCCCCON1C(C)(C)CC(OC(=O)OC(=O)OC2CC(C)(C)N(OCCCCCCCCCCC)C(C)(C)C2)CC1(C)C]

39. The polymer P according to claim 30, wherein the at least one diester or polyester B1 is selected from dimethyl succinate, diethyl succinate, or 1,2-cyclohexandicarboxylic diisononylester; the at least one diisocyanate or polyisocyanate B3 is selected from 2,4-toluene diisocyanate, 2,6-toluene diisocyanate, isophorondiisocyante, hexamethylene diisocyanate, or their dimer or trimer; the at least one epoxy polymer B4 comprises a monomer selected from trimethylolpropane triglycidyl ether, or bisphenol A diglycidyl ether; and the at least one maleic anhydride polymer B5 is styrene maleic anhydride copolymer.

40. The polymer P according to claim 30 having a weight average molecular weight in the range of 200 g/mol to 100,000 g/mol according to DIN 55672-1; a polydispersity index in the range of 1.1 to 4.0 according to according to DIN 55672-1; and a HALS content from 0.1 to 3.5 mmol HASL/g.

41. A method for preparing the polymer P according to claim 30, the method comprising:
i. mixing the at least one polyether A and the at least one hindered amine light stabilizer H selected from H2, H4, H6, or mixtures thereof; and
ii. heating the mixture obtained in step (i) at 80° C. to 200° C.

42. A method for preparing the polymer P according to claim 30, the method comprising:
i. mixing the at least one polyether A, the at least one hindered amine light stabilizer H selected from H1, H2, H3, H4, H5, H6, or mixtures thereof, and the at least one compound B selected from B1, B2, or B5; and
ii. heating the mixture obtained in step (i) at 80° C. to 200° C.

43. A method for preparing the polymer P according to claim 30, the method comprising:
(i) reacting the at least one polyether A and the at least one compound B selected from B3 or B4; and
(ii) reacting the product obtained in step (i) with the at least one hindered amine light stabilizer H selected from H1, H2, H3, H4, H5, H6, or mixtures thereof.

44. A liquid composition comprising the polymer P according to claim 30.

45. A liquid composition in the form of a dispersion comprising at least one fine particulate solid material and the at least one polymer P according to claim 30.

46. The liquid composition according to claim 45, further comprising at least one additive selected from filler, binder, wetting agent, rheology modifier, UV filter, defoamer, leveling agent, slip agent, substrate wetting agent, antioxidant, radical scavenger, biocide, or coalescing agent.

47. The liquid composition according to claim 46 in the form of a pigment paste, a millbase, a colorant, a coating composition, or an ink.

48. A coating composition comprising
i. the polymer P according to claim 30;
ii. at least one particulate solid material selected from pigments, fillers, or mixtures thereof;
iii. at least one liquid diluent, and
iv. at least one polymeric binder.
wherein the at least one particulate solid material is dispersed in a liquid diluent selected from organic solvents, water, reactive diluents, or mixture thereof.

49. A dispersant, a light stabilizer, or a coating composition comprising the polymer P according to claim 30.
